(19) United States
(12) Patent Application Publication
(10) Pub. No.: US 2025/0300900 A1
(43) Pub. Date: Sep. 25, 2025

(54) MACHINE LEARNING ASSISTED POSITION DETERMINATION

(71) Applicant: INTERDIGITAL PATENT HOLDINGS, INC., Wilmington, DE (US)

(72) Inventors: Kunjan Shah, London (GB); Fumihiro Hasegawa, Westmount (CA); Yugeswar Deenoo Narayanan Thangaraj, Chalfont, PA (US); Paul Marinier, Brossard (CA); Tuong Hoang, Montreal (CA); Jaya Rao, Montreal (CA); Moon IL Lee, Melville, NY (US); Janet Stern-Berkowitz, Little Neck, NY (US); Benoit Pelletier, Roxboro (CA)

(73) Assignee: INTERDIGITAL PATENT HOLDINGS, INC., Wilmington, DE (US)

(21) Appl. No.: 18/860,492

(22) PCT Filed: Apr. 27, 2023
(86) PCT No.: PCT/US2023/020245

§ 371 Date: Oct. 25, 2024

Related U.S. Application Data
(60) Provisional application No. 63/335,533, filed on Apr. 27, 2022.
(60) Provisional application No. 63/389,168, filed on Jul. 14, 2022.
(60) Provisional application No. 63/445,595, filed on Feb. 14, 2023.

(51) Int. Cl. H04L 41/16; H04B 17/318; H04W 24/02; H04W 64/00

(52) U.S. Cl. CPC H04L 41/16; H04B 17/328; H04W 24/02; H04W 64/006

(57) ABSTRACT

Methods, devices, and systems for machine learning (ML)-assisted position determination are disclosed. Information is received which indicates artificial intelligence/machine learning (AI/ML) models for determining position. Information is received which indicates transmission reference points (TRPs) (502, 504) associated with corners. Information is received which indicates a reference signal received power (RSRP). The TRPs associated with corners include a first TRP. It is determined that the WTRU is located in a corner based on an RSRP of a positioning reference signal (PRS) (506) received from the first TRP being above an RSRP threshold. Position information is determined based on an AI/ML position model and the determination that the WTRU is located in the corner. Information indicating the position of the WTRU is transmitted.

### RELATED APPLICATIONS

The present application claims the benefit of and priority to U.S. Provisional Application Nos. 63/335,533, entitled “Machine Learning Assisted Positioning,” filed Apr. 27, 2022; 63/389,168, entitled “Machine Learning Assisted Positioning,” filed Jul. 14, 2022; and 63/445,595, entitled “Machine Learning Assisted Positioning,” filed Feb. 14, 2023, the entirety of each of which are incorporated by reference herein.

### BACKGROUND

Downlink, uplink, and downlink and uplink techniques may be used for determining a position of a device in a wireless network environment, sometimes referred to as “position determination”, “position location”, “location determination”, “positioning”, or by similar terms or combinations of such terms. Such techniques may use positioning reference signals and/or sounding reference signals for position determination purposes. In some implementations, the environment plays a role in measurement of such reference signals, which may impact the positioning accuracy that is achievable by such position determination techniques.

### SUMMARY

Some implementations provide a method implemented in a wireless transmit/receive unit (WTRU). Information is received, indicating artificial intelligence/machine learning (AI/ML) models for determining position. Information is received which indicates transmission reference points (TRPs) associated with corners, and information indicating a reference signal received power (RSRP) threshold, the TRPs associated with corners including a first TRP. It is determined that that the WTRU is located in a corner based on an RSRP of a positioning reference signal (PRS) received from the first TRP being above the RSRP threshold. Position information of the WTRU is determined based on an AI/ML position model and the determination that the WTRU is located in the corner. Information indicating the position of the WTRU is transmitted.

In some implementations, the AI/ML position model includes a single-TRP fingerprinting AI/ML position model. In some implementations, the single-TRP fingerprinting AI/ML position model includes weights for a neural network. In some implementations, the AI/ML models for determining position include a support vector machine (SVM) or k-nearest neighbor (KNN) model. Some implementations include transmitting a request for the information indicating AI/ML models for determining position. In some implementations, the TRP is associated with a corner based on its proximity to a corner of a deployment environment. Some implementations include transmitting a request for a PRS to one or more TRPs. Some implementations include receiving a PRS from each of a plurality of TRPs including the first TRP. In some implementations, the WTRU has a line-of-sight (LOS) path to the first TRP. In some implementations, the inputs to the AI/ML position model include peak power or average power measurements of one or more transmissions from the first TRP.

Some implementations provide a WTRU. The WTRU includes receiver circuitry configured to receive information indicating artificial intelligence/machine learning (AI/ML) models for determining position. The receiver circuitry is configured to receive information indicating transmission reference points (TRPs) associated with corners. The receiver circuitry is also configured to receive information indicating a reference signal received power (RSRP) threshold, The TRPs associated with corners include a first TRP. The WTRU also includes processing circuitry configured to determine that the WTRU is located in a corner based on an RSRP of a positioning reference signal (PRS) received from the first TRP being above the RSRP threshold. The processing circuitry is also configured to determine position information based on an AI/ML position model and the determination that the WTRU is located in the corner. The WTRU also includes transmitter circuitry configured to transmit information indicating the position of the WTRU.

In some implementations, the AI/ML position model includes a single-TRP fingerprinting AI/ML position model. In some implementations, the single-TRP fingerprinting AI/ML position model includes weights for a neural network. In some implementations, the AI/ML models for determining position include a support vector machine (SVM) or k-nearest neighbor (KNN) model. In some implementations, the transmitter is further configured to transmit a request for the information indicating AI/ML models for determining position. In some implementations, a TRP is associated with a corner based on its proximity to a corner of a deployment environment. In some implementations, the transmitter is further configured to transmit a request for a PRS to one or more TRPs. In some implementations, the receiver is further configured to receive a PRS from each of a plurality of TRPs including the first TRP. In some implementations, the WTRU has a line-of-sight (LOS) path to the first TRP. In some implementations, the inputs to the AI/ML position model include peak power or average power measurements of one or more transmissions from the first TRP.

Some implementations provide a method implemented in a WTRU. Information is received which indicates artificial intelligence/machine learning (AI/ML) models for determining position. Information is received which indicates transmission reference points (TRPs) associated with line-of-sight (LOS) communications. Information is received which indicates a reference signal received power (RSRP) threshold. Information is received which indicates a threshold number of TRPs associated with LOS communications. A total number of TRPs associated with LOS communications is determined, for which RSRP measured on a received position reference signal (PRS) is below the RSRP threshold. It is determined that the WTRU is located in a non-line-of-sight (NLOS) environment based on the determined total number of TRPs being less than the threshold number of TRPs. Position information of the WTRU is determined based on an AI/ML position model and the determination that the WTRU is located in the NLOS environment. Information is transmitted indicating the position of the WTRU.

In some implementations, the position model includes a multi-TRP fingerprinting AI/ML position model. In some implementations, the multi-TRP fingerprinting AI/ML position model includes weights for a neural network. In some implementations, the AI/ML models for determining position include a support vector machine (SVM) or a k-nearest neighbor (KNN) model. Some implementations include transmitting a request for the information indicating AI/ML models for determining position. In some implementations, the indication of TRPs associated with LOS communications includes a list of TRP identifiers and an associated predetermined bit indicating either LOS or non-line-of-sight (NLOS). Some implementations include transmitting a request for a PRS to each of the TRPs associated with LOS communications. Some implementations include receiving a PRS from a plurality of TRPs associated with LOS communications. In some implementations, a LOS path to at least one of the TRPs associated with LOS communications is obscured. In some implementations, the inputs to the AI/ML position model include peak power or average power measurements of one or more transmissions from each of a plurality of TRPs associated with LOS communications.

Some implementations provide a WTRU. The WTRU includes receiver circuitry configured to receive information indicating artificial intelligence/machine learning (AI/ML) models for determining position. The receiver circuitry is further configured to receive information indicating transmission reference points (TRPs) associated with line-of-sight (LOS) communications, information indicating a reference signal received power (RSRP) threshold, and information indicating a threshold number of TRPs associated with LOS communications. The WTRU includes processing circuitry configured to determine a total number of TRPs associated with LOS communications for which RSRP measured on a received position reference signal (PRS) is below the RSRP threshold. The processing circuitry is further configured to determine that the WTRU is located in a non-line-of-sight (NLOS) environment based on the determined total number of TRPs being less than the threshold number of TRPs. The processing circuitry is further configured to determine position information based on an AI/ML position model and the determination that the WTRU is located in the NLOS environment. The WTRU includes transmitter circuitry is configured to transmit information indicating the position of the WTRU.

In some implementations, the position model includes a multi-TRP fingerprinting AI/ML position model. In some implementations, the multi-TRP fingerprinting AI/ML position model includes weights for a neural network. In some implementations, the AI/ML models for determining position include a support vector machine (SVM) or a k-nearest neighbor (KNN) model. In some implementations, the transmitter circuitry is further configured to transmit a request for the information indicating AI/ML models determining position. In some implementations, the indication of TRPs associated with LOS communications includes a list of TRP identifiers and an associated predetermined bit indicating either LOS or non-line-of-sight (NLOS). In some implementations, the transmitter is further configured to transmit a request for a PRS to each of the TRPs associated with LOS communications. In some implementations, the receiver is further configured to receive a PRS from a plurality of TRPs associated with LOS communications. In some implementations, a LOS path to at least one of the TRPs associated with LOS communications is obscured. In some implementations, inputs to the AI/ML position include peak power or average power measurements of one or more transmissions from each of a plurality of TRPs associated with LOS communications.

Some implementations provide methods, devices, and systems for machine learning (ML)-assisted position determination. An ML assisted non-line-of-sight (NLOS) identification request and capability information are sent to a network device. A first list of trained ML models and input features are received, responsive to the identification request and capability information. A model for NLOS identification is selected, based on a required rate of NLOS predictions. NLOS transmission-reception points (TRPs) are predicted based on the selected model. A position is determined based on the predicted NLOS TRPs.

In a first aspect, the present disclosure is directed to a method implemented in a wireless transmit/receive unit (WTRU) for machine learning-assisted position determination. The method includes receiving artificial intelligence/machine learning (AI/ML) models for AI/ML assisted positioning. The method also includes receiving an indication of transmission reference points (TRPs) associated with corners, and an indication of a reference signal received power (RSRP) threshold, the TRPs associated with corners including a first TRP. The method also includes determining that the WTRU is located in a corner based on an RSRP of a positioning reference signal (PRS) received from the first TRP being above the RSRP threshold. The method also includes obtaining, by the WTRU, a position of the WTRU using single-TRP fingerprinting AI/ML positioning, based on the determination that the WTRU is located in the corner. The method also includes transmitting an indication of the position of the WTRU.

In a second aspect, the present disclosure is directed to a device for machine learning-assisted position determination, the device including a wireless transmit/receive unit (WTRU) including a receiver, a processor, and a transmitter. The receiver is configured to: receive artificial intelligence/machine learning (AI/ML) models for AI/ML assisted positioning; and receive an indication of transmission reference points (TRPs) associated with corners, and an indication of a reference signal received power (RSRP) threshold, the TRPs associated with corners including a first TRP. The processor is configured to: determine that the WTRU is located in a corner based on an RSRP of a positioning reference signal (PRS) received from the first TRP being above the RSRP threshold; and obtain a position of the WTRU using single-TRP fingerprinting AI/ML positioning, based on the determination that the WTRU is located in the corner. The transmitter is configured to transmit an indication of the position of the WTRU.

In a third aspect, the present disclosure is directed to a method implemented in a wireless transmit/receive unit (WTRU) for machine learning (ML)-assisted position determination. The method includes receiving artificial intelligence/machine learning (AI/ML) models for AI/ML assisted positioning. The method also includes receiving an indication of transmission reference points (TRPs) associated with line-of-sight (LOS) communications, an indication of a reference signal received power (RSRP) threshold, and an indication of a threshold number of TRPs associated with LOS communications. The method also includes determining a total number of TRPs associated with LOS communications for which RSRP measured on a received position reference signal (PRS) is below the RSRP threshold. The method also includes determining that the WTRU is located in a non-line-of-sight (NLOS) environment based on the determined total number of TRPs being less than the threshold number of TRPs. The method also includes obtaining, by the WTRU, a position of the WTRU using multi-TRP fingerprinting AI/ML positioning, based on the determination that the WTRU is located in the NLOS environment. The method also includes transmitting an indication of the position of the WTRU.

In a fourth aspect, the present disclosure is directed to a device for machine learning (ML)-assisted position determination. The device includes a wireless transmit/receive unit (WTRU) including a receiver, a processor, and a transmitter. The receiver is configured to: receive artificial intelligence/machine learning (AI/ML) models for AI/ML assisted positioning; and receive an indication of transmission reference points (TRPs) associated with line-of-sight (LOS) communications, an indication of a reference signal received power (RSRP) threshold, and an indication of a threshold number of TRPs associated with LOS communications. The processor is configured to: determine a total number of TRPs associated with LOS communications for which RSRP measured on a received position reference signal (PRS) is below the RSRP threshold; determine that the WTRU is located in a non-line-of-sight (NLOS) environment based on the determined total number of TRPs being less than the threshold number of TRPs; obtain a position of the WTRU using multi-TRP fingerprinting AI/ML positioning, based on the determination that the WTRU is located in the NLOS environment. The transmitter is configured to transmit an indication of the position of the WTRU.

In a fifth aspect, the present disclosure is directed to a method for machine learning-assisted position determination. The method includes identifying, by a wireless transmit/receive unit (WTRU), a spatial configuration of the WTRU relative to one or more transmission-reception points (TRPs). The method also includes selecting, by the WTRU based on the identified spatial configuration, a position determination algorithm from a plurality of position determination algorithms, the position determination algorithms including at least one trained ML model. The method also includes determining, by the WTRU, a position of the WTRU using the selected position determination algorithm. In some embodiments, the method includes determining that the WTRU is associated with a corner within the environment, responsive to detecting that a positioning reference signal (PRS) received by the WTRU from a TRP associated with the corner exceeds a threshold. In a further embodiment, the method includes selecting a single-TRP fingerprinting ML model, responsive to determining that the WTRU is associated with the corner within the environment. In some embodiments, the method includes determining that the WTRU is in a non-line-of-sight (NLOS) environment. In a further embodiment, the method includes selecting a multi-TRP fingerprinting ML model, responsive to determining that the WTRU is in the NLOS environment.

In a sixth aspect, the present disclosure is directed to a device for machine learning-assisted position determination. The device includes a wireless transmit/receive unit (WTRU) including a processor. The processor is configured to: identify a spatial configuration of the WTRU relative to one or more transmission-reception points (TRPs); select, based on the identified spatial configuration, a position determination algorithm from a plurality of position determination algorithms, the position determination algorithms including at least one trained ML model; and determine a position of the WTRU using the selected position determination algorithm. In some embodiments, the processor is further configured to determine that the WTRU is associated with a corner within the environment, responsive to detecting that a positioning reference signal (PRS) received via a receiver from a TRP associated with the corner exceeds a threshold. In a further embodiment, the processor is further configured to select a single-TRP fingerprinting ML model, responsive to determining that the WTRU is associated with the corner within the environment. In some embodiments, the processor is further configured to determine that the WTRU is in a non-line-of-sight (NLOS) environment. In a further embodiment, the processor is further configured to select a multi-TRP fingerprinting ML model, responsive to determining that the WTRU is in the NLOS environment.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating example RSRP fingerprints;

FIG. 3 is a system diagram illustrating an example NLOS propagation link between a WTRU and TRP;

FIG. 4 is a system diagram illustrating Impact of reference TRP position on achieved position determination accuracy;

FIG. 5 is a system diagram illustrating an example WTRU in a context where it is capable of receiving a limited number of PRSs;

FIG. 6 is a block diagram illustrating an example artificial neural network;

FIG. 7 is a system diagram illustrating an example WTRU in a mixed LOS/NLOS environment;

FIG. 8 is a message sequence chart illustrating an example model selection procedure;

FIG. 9 is a flow chart which illustrates an example procedure for determining a multistage ML model

FIG. 10 is a block diagram illustrating an example model deployment procedure for fingerprinting-based position determination;

FIG. 11 is a block diagram illustrating an example model training procedure for fingerprinting-based position determination;

FIG. 12 is a perspective and plan view of an example deployment of a WTRU;

FIG. 13 is another perspective and plan view of an example deployment of a WTRU;

FIG. 14 is a block diagram illustrating a input and output for an example ML-assisted position estimation implementation;

FIG. 15 is a block diagram illustrating an example ML-assisted position estimation scenario;

FIG. 16 is a block diagram illustrating an example training procedure for ML assisted position estimation;

FIG. 17 is a system diagram illustrating an example WTRU in a context where it is located in a corner;

FIG. 18 is a system diagram illustrating an example WTRU in an example scenario where the WTRU is located in an example NLOS environment;

FIG. 19 is a system diagram illustrating an example WTRU in an example scenario where the WTRU is in an LOS environment; and

FIG. 20 is a flow chart illustrating an embodiment of a method for ML-assisted position estimation.

### DETAILED DESCRIPTION

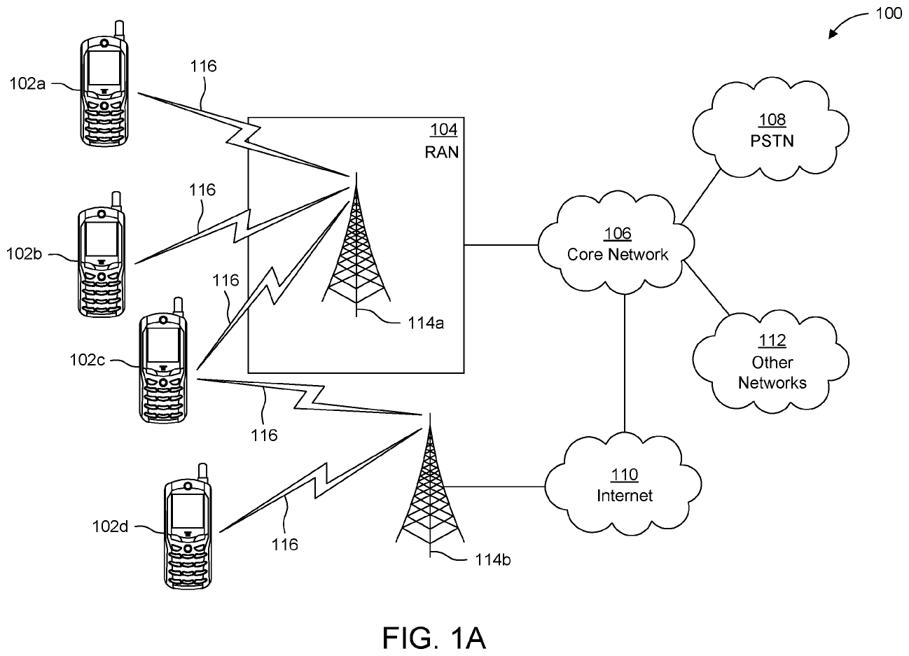

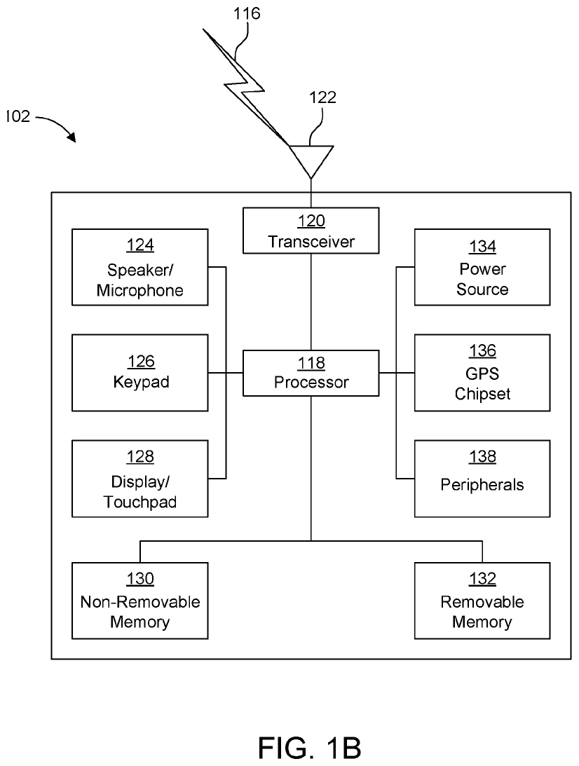

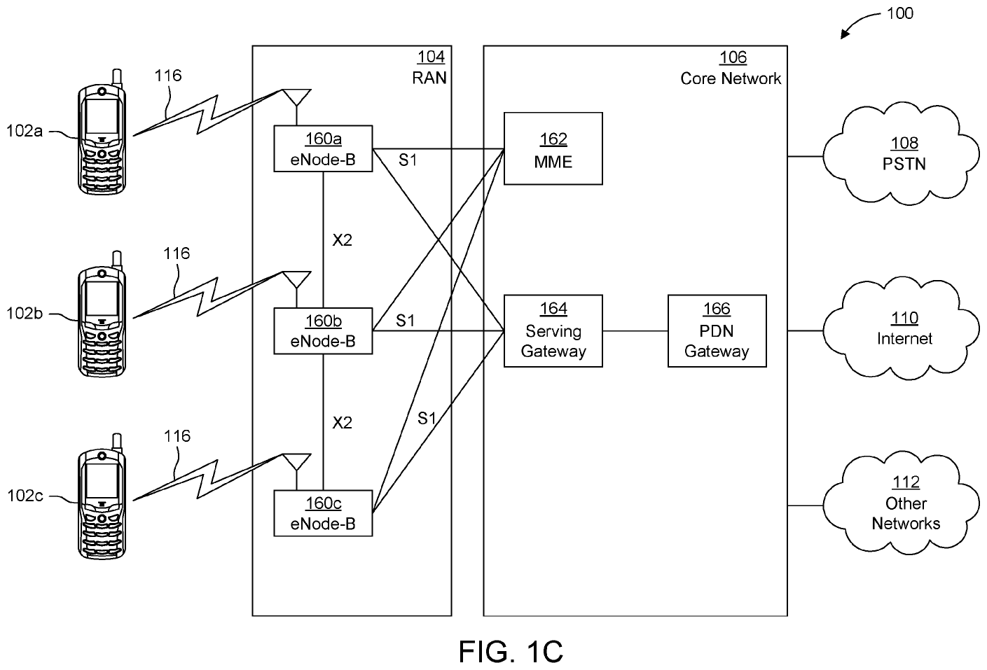

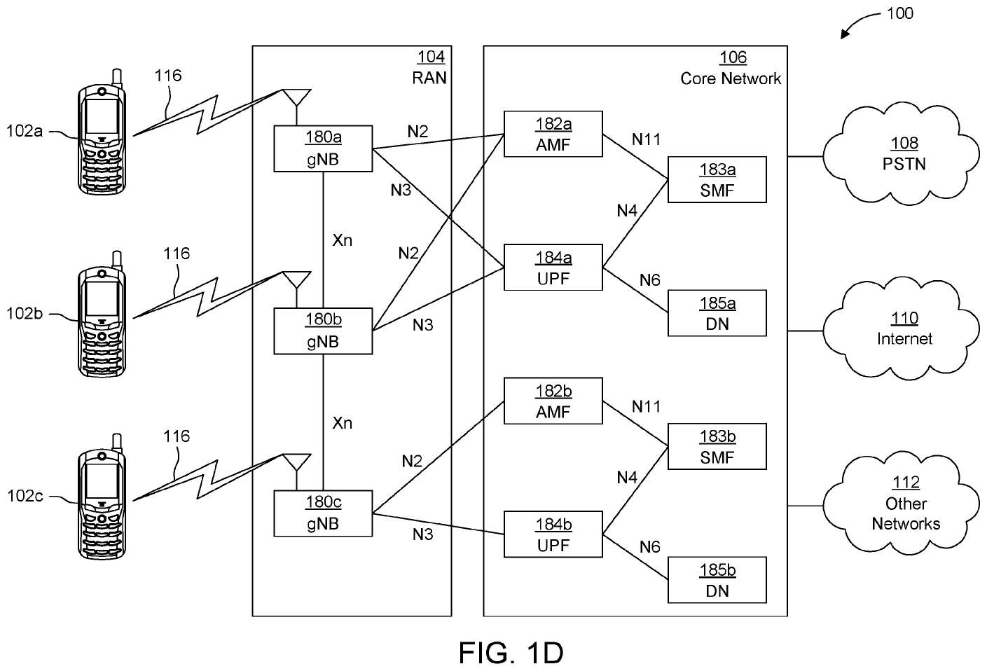

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102dto facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In Rel. 17 in 3GPP, downlink, uplink and downlink and uplink techniques may be used for position determination. Such techniques may use positioning reference signals, sounding reference signals and sounding reference signals for positioning purposes. In some implementations, the environment plays a role in measurement of such reference signals, which may impact the positioning accuracy that is achievable by such position determination techniques.

In NR positioning or position determination, a WTRU may be unable to receive PRS from a sufficient or required number (and/or quality) of LOS TRPs which may lead to positioning inaccuracy. In some cases, such as in an unknown environment or due to the mobility of the WTRU, the WTRU may not have environmental information available. In some implementations, a model may be used to determine these environmental conditions and may be utilized to enhance positioning performance (e.g., by selecting TRPs, positioning technique, and/or ML model (fingerprinting) based positioning).

An example procedure for ML assisted positioning or position determination is as follows. Based on predefined conditions (e.g., achieved positioning accuracy lesser than a threshold), the WTRU sends an ML assisted NLOS identification request to the network. The WTRU sends its capability information to the network. For example, capability information may indicate that the WTRU is capable of NLOS identification, e.g., using a Support Vector Machine (SVM) algorithm. Alternatively, capability information may indicate that the WTRU is capable of NLOS identification using more than one method, e.g., SVM and neural network based algorithm. The WTRU receives a list of trained models (e.g., Support Vector Machine, K—Nearest Neighbor, etc.) and input features (e.g., peak power, average power, etc.) for AI/ML based NLOS identification from the network. The WTRU receives PRS priority level from the TRP. The WTRU makes measurements on PRS from the network. The WTRU determines a model for NLOS identification based on required number of NLOS estimations per second. if the NLOS estimation time of any models exceeds the maximum allowed NLOS estimation time, the WTRU requests network to provide a new set of models which require shorter NLOS estimation time. If the NLOS estimation can be completed in time, the WTRU indicates the selected model to the network. The WTRU predicts/identifies NLOS and/or LOS TRPs using the AI/ML model. Based on a predefined requirement for a conventional positioning algorithm (e.g., minimum number of LOS TRPs>3), the WTRU sends a request to the network whether network should perform conventional positioning or ML model-based (e.g., fingerprinting) positioning. If the WTRU sends a request to network to use conventional positioning technique, it provides a set of (LOS) TRP IDs (e.g., TRP ID-34, TRP ID-27 etc.) to perform conventional TRPs to the network.

Various abbreviations and acronyms are used herein, e.g., as follows:
ACK Acknowledgement
AoA Angle of Arrival
AoD Angle of Departure
ARFCN Absolute Radio-Frequency Channel Number
BLER Block Error Rate
BWP Bandwidth Part
CAP Channel Access Priority
CAPC Channel access priority class
CCA Clear Channel Assessment
CCE Control Channel Element
CE Control Element
CG Configured Grant or Cell Group
CORESET Control Resource Set
CP Cyclic Prefix
CP-OFDM Cyclic Prefix OFDM
CQI Channel Quality Indicator
CRO Cyclic Redundancy Check
CSI Channel State Information
CW Contention Window
CWS Contention Window Size
CO Channel Occupancy
DAI Downlink Assignment Index
DCI Downlink Control Information
DFI Downlink feedback information
DG Dynamic grant
DL Downlink
DM-RS Demodulation Reference Signal
DRB Data Radio Bearer
DRX Discontinuous Reception
ECID Enhanced Cell ID
eLAA enhanced Licensed Assisted Access
eMBB enhanced Mobile Broadband
FeLAA Further enhanced Licensed Assisted Access
HARQ Hybrid Automatic Repeat Request
IM Interference Measurement
KNN k Nearest Neighbor
LAA License Assisted Access
LBT Listen Before Talk
LCH Logical Channel
LCP Logical Channel Priority
LBT Listen-Before-Talk
LOS Line of Sight
NLOS Non Line of Sight
LMF Location Management Function
LPP LTE Positioning Protocol
LTE Long Term Evolution e.g. from 3GPP LTE R8 and up
MAC CEMAC Control Element
MAC Medium Access Control
MCS Modulation and Coding Scheme
MIMO Multiple Input Multiple Output
NACK Negative ACK
NAS Non-access stratum
NR New Radio
OFDM Orthogonal Frequency-Division Multiplexing
OTDOA Observed Time Difference of Arrival
PDCCH Physical Downlink Control Channel
PDSCH Physical Downlink Shared Channel
PDU Packet Data Unit
PHY Physical Layer
PID Process ID
PO Paging Occasion
PRACH Physical Random Access Channel
PRS Positioning Reference Signal
PRU Positioning Reference Unit
PSS Primary Synchronization Signal
PTRS Phase Tracking Reference Signal
PUCCH Physical Uplink Control Channel
PUSCH Physical Uplink Shared Channel
RA Random Access (or Random Access procedure)
RACH Random Access Channel
RAR Random Access Response
RCU Radio access network Central Unit
RF Radio Front end
RLF Radio Link Failure
RLM Radio Link Monitoring
RNTI Radio Network Identifier
RNA RAN Notification Area
RO RACH occasion
RRC Radio Resource Control
RRM Radio Resource Management
RTT Round Trip Time
RP Reception Point
RS Reference Signal
RSRP Reference Signal Received Power
RSTD Reference Signal Time Difference
RTT Round Trip Time
RSSI Received Signal Strength Indicator
RTOA Relative Time of Arrival
SDAP Service data adaptation protocol
SDU Service Data Unit
SRB Signaling Radio Bearer
SRS Sounding Reference Signal
SS Synchronization Signal
SSS Secondary Synchronization Signal
SWG Switching Gap (in a self-contained subframe)
SPS Semi-persistent scheduling
SUL Supplemental Uplink
SVM Support Vector Machine
TB Transport Block
TBS Transport Block Size
TDoA Time Difference of Arrival
TRP Transmission-Reception Point
TSC Time-sensitive communications
TSN Time-sensitive networking
TTI Transmission Time Interval
UCI Uplink Control Information
UL Uplink
URLLC Ultra-Reliable and Low Latency Communications
WBWP Wide Bandwidth Part
WLAN Wireless Local Area Networks and related technologies (IEEE 802.xx domain)

Various techniques are used to determine the position of a device, such as a WTRU. For example, downlink, uplink and downlink and uplink techniques may be used for position determination. Some implementations include one or more of the following types of techniques: DL positioning; UL positioning; and DL & UL positioning.

DL positioning may refer to any position determination techniques that are based on downlink reference signals, such as PRS. For example, in some implementations, a WTRU receives multiple reference signals from a TP or TPs, and measures DL RSTD and/or RSRP. Examples of DL positioning include DL-AoD and DL-TDOA positioning.

UL positioning may refer to any position determination techniques that are based on uplink reference signals, such as SRS. For example, in some implementations, a WTRU transmits SRS to multiple RPs and the RPs measure the UL RTOA and/or RSRP. Examples of UL positioning include UL-TDOA or UL-AoA positioning.

DL & UL positioning may refer to any position determination techniques that are based on both uplink and downlink reference signals. For example, in some implementations, a WTRU transmits SRS to multiple TRPs and a gNB measures the Rx-Tx time difference. In some implementations, the gNB may measure RSRP for the received SRS. In some implementations, the WTRU measures the Rx-Tx time difference for PRS transmitted from multiple TRPs. In some implementations, the WTRU may measure RSRP for the received PRS. In some implementations, the Rx-TX difference and/or RSRP measured at WTRU and gNB are used to compute round trip time. Here, Rx-TX difference refers to the difference between arrival time of the reference signal transmitted by the TRP and transmission time of the reference signal transmitted from the WTRU. Examples of DL & UL positioning include multi-RTT positioning.

“DL positioning method” may refer to any position determination method that uses downlink reference signals such as PRS. The WTRU receives multiple reference signals from TP(s) and measures DL RSTD and/or RSRP. Examples of DL positioning methods are DL-AoD or DL-TDOA positioning.

“UL positioning method” may refer to any position determination method that uses uplink reference signals such as SRS for positioning. The WTRU transmits SRS to multiple RPs and the RPs measure the UL RTOA and/or RSRP. Examples of UL positioning methods are UL-TDOA or UL-AoA positioning

“DL & UL positioning method” may refer to any position determination method that uses both uplink and downlink reference signals for positioning. In one example, a WTRU transmits SRS to multiple TRPs and gNB measures Rx-Tx time difference. The gNB can measure RSRP for the received SRS. The WTRU measures Rx-Tx time difference for PRS transmitted from multiple TRPs. The WTRU can measure RSRP for the received PRS. The Rx-TX difference and possibly RSRP measured at WTRU and gNB are used to compute round trip time. Here Rx and Tx difference refers to the difference between arrival time of the reference signal transmitted by the TRP and transmission time of the reference signal transmitted from the UE. An example of DL & UL positioning method is multi-RTT positioning. Hereafter for the sake of distinguishing from ML assisted positioning, we will refer “DL positioning method”,” UL positioning method” and “DL & UL positioning method” as non-ML positioning methods.

“Machine Learning (ML) assisted positioning method” may refer to any positioning method that uses a trained ML model to convert predefined input measurements to directly predict the WTRU's position as an output of the model or predict measurements or parameters (e.g., LOS/NLOS indicator, TDOA, PRS-RSRP etc.) which may be used by non-ML positioning technique at later stage to obtain the WTRU's position. In some cases, the term “artificial intelligence machine learning” (AIML) is used interchangeably with the term ML.

Some implementations relate to RSRP fingerprinting. An RSRP fingerprint may refer to a combination of RSRP values of reference signals which may be transmitted from multiple TRPs, multiple beams of the same TRP or combination of both. A WTRU may generate a RSRP fingerprint based on one or more PRS received from reference TRP or multiple neighboring TRPs. WTRUs located within a certain distance (e.g., predefined or preconfigured) from each other can measure similar RSRP (e.g., low, high) in PRS measurements, which can be RSRP fingerprints.

In some implementations, an RSRP fingerprint may be generated based on alternative measurements representing the signal strength of a signal. Examples of alternative RSRP include: RSRQ; SINR; QI; and/or Difference of RSRP values.

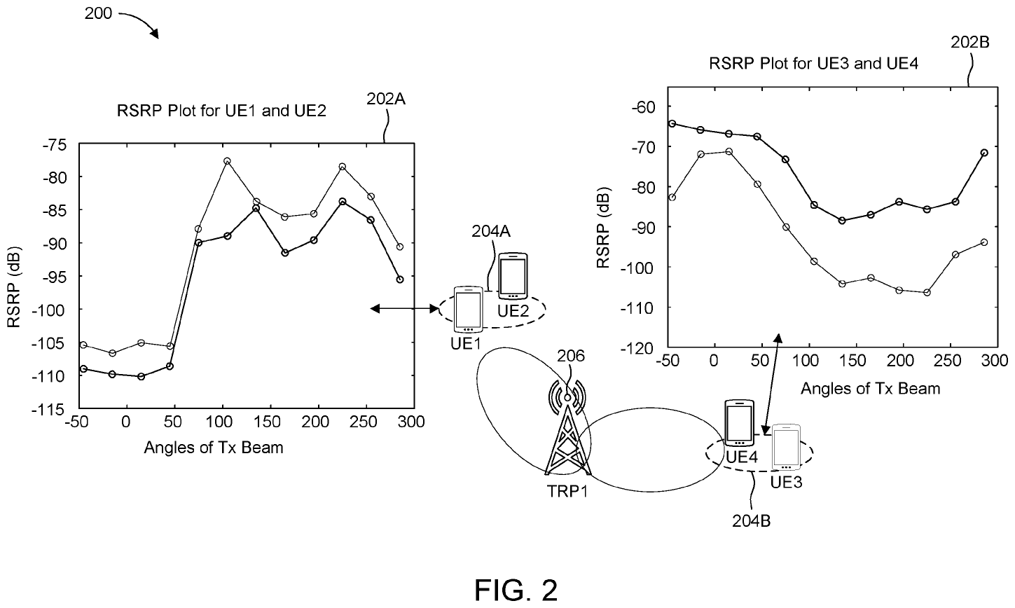

FIG. 2 is a system diagram 200 illustrating example RSRP fingerprints in a wireless environment. In this example, each RSRP fingerprint is generated by measuring PRS-RSRP transmitted from 12 Tx beams (each one with unique Tx angle) of a single TRP 206. WTRUs UE 1 and UE 2 are located within a certain distance from each other (indicated as group 204A), therefore we observe that they exhibit similar RSRP fingerprints (as shown in graph 202A, with the upper line corresponding to UE1 and lower line corresponding to UE2). We observe the same phenomenon for WTRUs UE 3 and UE 4 (indicated as group 204B and fingerprints 202B, with the lower line corresponding to UE3, and the upper line corresponding to UE4). In some implementations, in case of an NLOS environment between a WTRU and TRP, the correlation of fingerprint to geographical location remains valid. For example, UE1 and UE2 experience NLOS, while UE3 and UE4 experience LOS in FIG. 2.

In some cases, environmental conditions may impact positioning accuracy. For example, for timing-based positioning techniques (e.g., DL positioning, UL positioning and DL & UL positioning), environmental conditions may influence the achievability of positioning accuracy. Examples of such environmental factors include: one or more LOS/NLOS conditions between WTRU and TRP link; the location of one or more reference TRPs which send PRS to the WTRUs; and/or a number of TRPs from which a WTRU can detect PRS.

An example environmental parameter which may impact achievable positioning accuracy is the NLOS condition between WTRU and TRP link. For example, in an NLOS environment, a WTRU may receive PRS with multipath reflections.

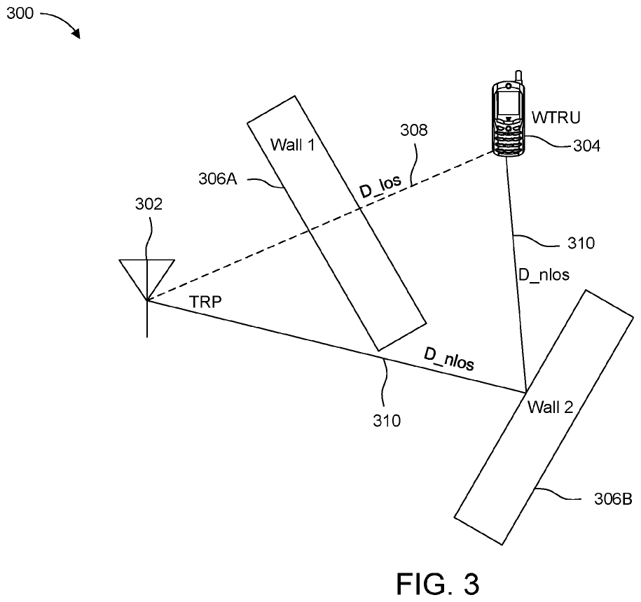

FIG. 3 is a system diagram 300 illustrating an example NLOS propagation link between a WTRU 304 and TRP 302. In this example, a wall 306A is located between WTRU 304 and TRP 302 which blocks line of sight propagation (marked in dotted line 308). To overcome this blockage condition, a WTRU 304 receives a reflected signal 310 from wall 2 306B. It is observed that the distance travelled by the reflected signal 310 is greater than the hypothetical LOS propagation 308.

In some implementations, such reflected measurement may include a positive bias in addition to the actual time difference which might have been measured under LOS conditions between the WTRU 304 and TRP 302 pair. Such bias to timing difference measurements may be propagated to timing difference measurements. In such cases, if a timing-based positioning technique is applied to such biased timing difference measurements, it may provide a positioning output indicating a further distance than the correct distance, which may lead to inaccuracy.

Another factor which may limit achievable positioning accuracy is the location of the TRPs. In some implementations, error is associated with each propagation delay measurement. If TRPs are located in a line, or in a cluster, for example, positioning accuracy may degrade due to lack of sufficient TRP resolution from the perspective of the WTRU.

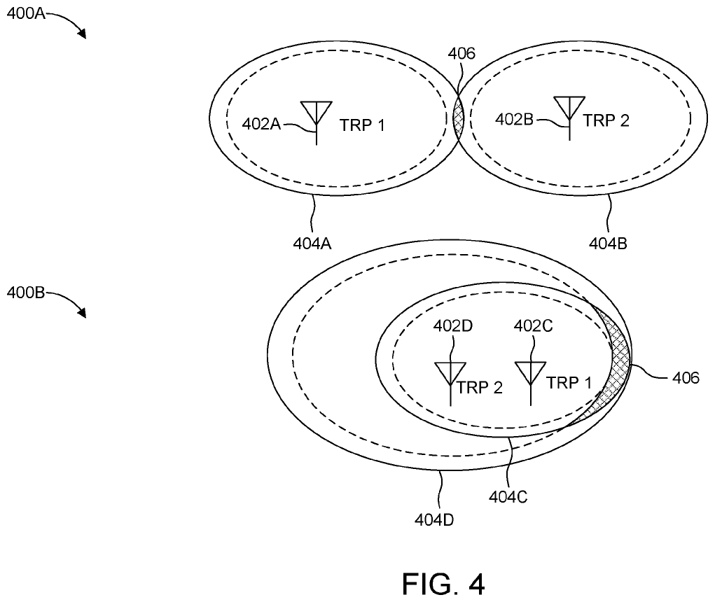

FIG. 4 is a system diagram illustrating example impacts of reference TRP position on achieved positioning accuracy. In this example, measurement uncertainty is shown with respect to sparsely located TRPs 402A, 402B with example measurement ranges 404A, 404B (top, 400A) and lined-up/clustered TRPs 402C, 402D with example measurement ranges 404C, 404D (bottom 400B), with the uncertainty regions shaded (406, in hash marks). In some implementations, the same phenomenon is applicable to timing difference-based positioning techniques.

For timing difference-based positioning techniques, in some implementations, PRS coverage of a WTRU is based on at least 4 non-collocated TRPs. However, in some cases the WTRU may receive PRS from less than 4 reference TRPs; e.g., due to WTRU location (e.g., where the WTRU is located in a corner of a building), lack of PRS resources from certain TRPs, or combination of both.

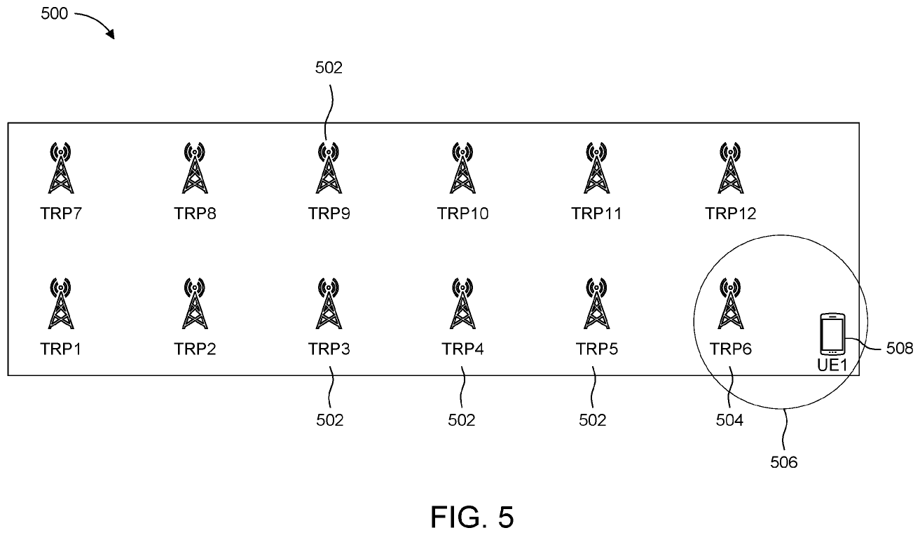

FIG. 5 is a system diagram 500 illustrating an example WTRU 508 (UE1 in the figure) in a context where it is capable of receiving a limited number of PRSs. In this example, WTRU 508 receives PRS from only one TRP; i.e., WTRU 508 can receive PRS 506 only from TRP6 504, with PRSs from remaining TRPs 502 out of range, blocked, or otherwise unavailable.

Some implementations include Artificial Intelligence (AI). Artificial intelligence may broadly refer to behavior exhibited by machines that mimic cognitive functions to sense, reason, adapt and act. Some implementations include Machine Learning (ML). Machine learning may broadly refer to algorithms that solve a problem based on learning through experience (e.g., ‘data’), without explicitly being programmed (e.g., ‘configuring set of rules’). Machine learning may be considered a subset of AI. Different machine learning paradigms may be envisioned based on the nature of data or feedback available to the learning algorithm. For example, a supervised learning approach may include learning a function that maps input to an output based on labeled training example, wherein each training example may include a pair which includes input and the corresponding output. An unsupervised learning approach may include detecting patterns in the data with no pre-existing labels. A reinforcement learning approach may include performing sequence of actions in an environment to maximize the cumulative reward. In some implementations, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning may be considered to fall between unsupervised learning (with no labeled training data) and supervised learning (with only labeled training data).

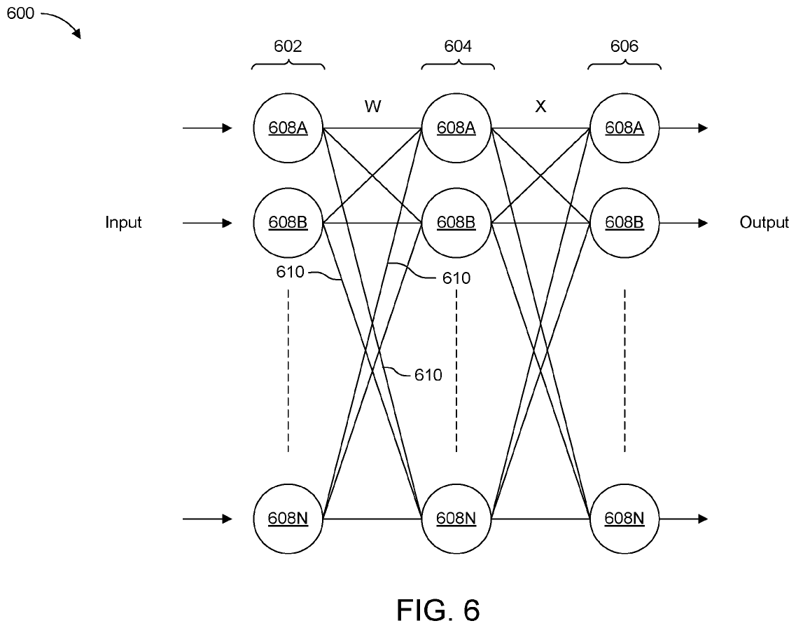

Some implementations include artificial neural networks (ANNs). FIG. 6 is a block diagram illustrating an example artificial neural network 600.

In some implementations, the objective of training is to apply input and to adjust weights, indicated as w and x in the figure (which may be referred to as neuron weights or link weights), such that the output from the neural network approaches desired target values which are associated with the input values. In the example, an artificial neural network includes 3 layers 602, 604, 606, although other numbers of layers may be utilized in various embodiments, which each layer including one or more nodes 608A-608N, connected by one or more edges or connections 610. In some implementations, during training of the artificial neural network, for given input, the difference between output and desired values are computed and difference is used to update the weights in the neural network. If relatively larger differences between output and desired values are observed, relatively larger changes in the weights may be made, whereas if relatively small differences between the output and desired values are observed, relatively smaller changes in the weights may be made.

In some implementations, for positioning, the input may include reference signal parameters, and the output may be an estimated position. In some implementations, the desired value may include location information acquired by a global navigation satellite system (GNSS) (e.g., with high accuracy) or another suitable reference source.

In some implementations, after the artificial neural network completes its training (e.g., after the difference between the output and desired values is below a threshold), the artificial neural network may be applied for positioning tasks by inputting and use the output as the expected outcome for the associated input. The output may be estimated position or location of the WTRU.

The following information may be used for training a neural network: an input to the neural network; an expected output associated with the input; and an actual output from the neural network against which the expected output is compared. An example neural network model may be characterized by the following parameters: a number of weights; and/or a number of layers in the neural network

Deep learning (DL) may refer to class of machine learning algorithms that employ artificial neural networks, specifically Deep Neural Networks (DNNs) which were loosely inspired from biological systems, and include at least one hidden layer. DNNs are a class of machine learning models inspired by the human brain, wherein the input is linearly transformed and pass through non-linear activation functions multiple times. DNNs typically include multiple layers where each layer includes linear transformation and non-linear activation functions. In some implementations, DNNs may be trained using training data via back-propagation. DNNs may provide high performance in a variety of domains, such as speech, vision, natural language etc. and for various machine learning settings (e.g., supervised, un-supervised, and semi-supervised).

As used herein, “Network” may include, for example, AMF, LMF, gNB or NG-RAN. “Pre-configuration” and “configuration” may be used interchangeably. “non-serving gNB” and “neighboring gNB” may be used interchangeable. “gNB” and “TRP” may be used interchangeably. “PRS” or “PRS resource” may be used interchangeably. “PRS(s)” or “PRS resource(s)” may be used interchangeably. The aforementioned “PRS(s)” or “PRS resource(s)” may belong to different PRS resource sets. “PRS” or “DL-PRS” or “DL PRS” may be used interchangeably. “Measurement gap” or “Measurement gap pattern” may be used interchangeably. “Measurement gap pattern” may include parameters such as measurement gap duration or measurement gap repetition period or measurement gap periodicity. The terms, “events” or “occasions” may be used interchangeably.

A PRU may include any suitable device, such as a WTRU or TRP, whose location (e.g., altitude, latitude, geographic coordinate, or local coordinate) is known by the network (e.g., gNB, LMF). The capabilities of a PRU may be same as a WTRU or TRP, e.g., capable of receiving PRS or transmit SRS or SRS for positioning, return measurements, or transmit PRS. WTRUs acting as PRUs may be used by the network for calibration purposes (e.g., to correct unknown timing offset, and/or correct unknown angle offset).

An LMF is a non-limiting example of a node or entity (e.g., network node or entity) that may be used for or to support positioning. Any other node or entity may be substituted for LMF and still be consistent with the techniques described herein.

As discussed earlier, Artificial Intelligence (AI) is a branch of science which solves problems by enabling machines to mimic human behavior. Machine learning (ML) is a subset of artificial intelligence which focuses on solving problem by learning from data and making predictions. The terms AI and ML are used interchangeably herein.

A mathematical model is a mathematical equation which approximates relationship between one or more variables (input) with another variable (output). A model may be created, for example, based on ML techniques.

Model training may include a procedure where model is provided with input variables and output variables to learn from. Model deployment may include a process of deploying a trained model in real world to make prediction or estimate output. Model inference is a process of providing an input variable or variables to a model and predicting/calculating the output. For the scope of this disclosure, the terms model deployment and model inference are used interchangeably. Model monitoring may include a process of monitoring accuracy of output prediction of a particular model. Model accuracy may refer to a metric to compare different classification models, defined as number of correct predictions made by a model to total sample size. Model updating may refer to a procedure where one model is replaced by another model for prediction.

In some cases, positioning accuracy may be degraded, e.g., due to poor environmental conditions. For example, in NR positioning, WTRU may not be able to receive PRS from minimum number of TRPs (e.g., as in the example of a WTRU located in a corner of a building) required for a particular positioning method (e.g., 4 for DL-TDOA), resulting in positioning accuracy degradation. Examples of poor environmental conditions include, for example, an WTRU is in NLOS with all TRPs, TRPs concentrated in one area, situations where the WTRU can receive PRS only from one or two TRPs, and so forth.

Some implementations include Machine Learning-assisted NLOS Identification. In some implementations a WTRU may be configured to train a machine learning model according to a preconfigured set of inputs and preconfigured set of outputs. For example, the set of inputs and outputs may be based on one or more of the following: WTRU measurements, sensor data, imaging/video data, positioning information from GNSS or another suitable reference source, inputs from the network such as data and/or assistance information, outputs of positioning methods, etc.

In some implementations, an NLOS reference TRP may impact positioning accuracy. For example, a WTRU may be located in a mixed LOS/NLOS environment such that WTRU is in a LOS situation with more than one TRP while in a NLOS situation with the rest of the TRPs, out of all TRPs from which a WTRU can detect PRS.

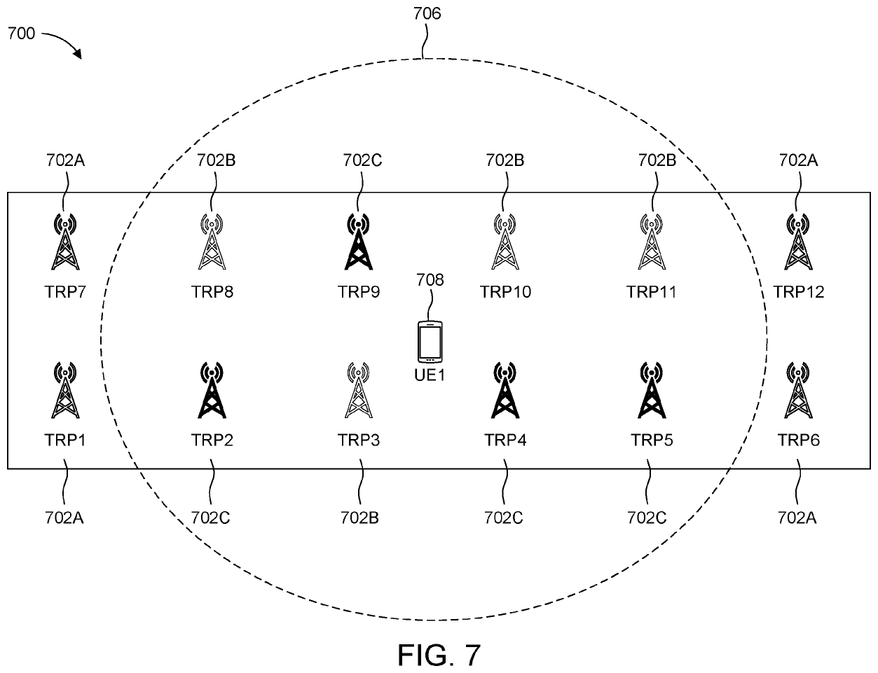

FIG. 7 is a system diagram 700 illustrating an example WTRU 708 (UE1 in the figure) in a mixed LOS/NLOS environment. In this example, 12 TRPs 702A-702C are deployed in an indoor scenario. Based on the location and radio condition of the WTRU, it can detect PRS from 8 different TRPs (within the dashed oval 706). Out of these 8 TRPs, 4 TRPs are LOS 702B and 4 are in NLOS 702C condition with the WTRU. LOS TRPs 702B are TRP3, TRP8, TRP10, TRP11 (illustrated in outline within dashed oval 706) while NLOS TRPs 702C are TRP2, TRP4, TRP5, TRP9 (illustrated in solid line within dashed oval 706). In some implementations, if a subset of neighboring TRPs are chosen for PRS transmission and subsequent TDOA measurements (e.g., RSTD) are taken without considering the NLOS condition, the measured TDOA measurement may include positive measurement bias, leading to positioning inaccuracy.

In some implementations, a WTRU may receive a predefined positioning accuracy threshold from the network (e.g., from an LMF or gNB). The WTRU may evaluate positioning accuracy as follows. Based on a positioning method configured by the network (e.g., WTRU-based DL-TDOA, WTRU-based DL-AoD), the WTRU may obtain the estimated location information. The WTRU may obtain a reference location information via RAT independent positioning methods (e.g., GNSS). The WTRU may evaluate positioning accuracy by comparing the estimated location information and the reference location information. If evaluated positioning accuracy is below the threshold, the WTRU may initiate ML model assisted NLOS identification.

In some implementations, the WTRU may receive an indication from the network to initiate ML model based NLOS identification. After the WTRU receives the indication, the WTRU may receive one or more configurations related to training of the ML model.

In some implementations, during an ANN training phase, the WTRU may obtain a reference LOS/NLOS condition (e.g., a reference LOS/NLOS condition refers to an indication of whether the channel is LOS or NLOS, e.g., expressed in 0 or 1. The condition may be estimated or generated by the network.) with respect to each TRP. The reference LOS/NLOS condition may be indicated to the WTRU using a LOS/NLOS indicator. In some implementations, the LOS/NLOS indicator may be a “hard” indicator (e.g., 0 or 1) which indicates a fully LOS or fully NLOS condition, or a “soft” indicator which may indicate a value between fully LOS and fully NLOS (e.g., a value between 0 and 1, inclusive).

In some implementations, during the training phase, the WTRU trains the model based on preconfigured inputs and the associated outputs. Example preconfigured inputs may include, channel impulse response data (e.g., multiple taps where each tap is associated with relative delay with respect to the first tap and relative power with respect to the tap with the highest power); peak power (e.g., peak RSRP) data; average power (e.g., mean RSRP) data; peak to average power ratio data; skewness of channel impulse response data; and/or kurtosis of channel impulse response data.

The output may include labelled outputs (whose “actual value” is known). For example, the actual output may include an LOS indicator. For example, a hard LOS indicator for the WTRU 708 shown in FIG. 7 (UE1), labelled output, may be as follows: TRP2-0, TRP3-1, TRP4-0, TRP5-0, TRP8-1, TRP9-0, TRP10-1, TRP11-1. In this example, 0 represents NLOS condition and 1 indicates LOS condition.

In another example, the WTRU 708 may use RSRP measurements made on a configured PRS resource and associate them with the LOS indicator. For example, after fulfillment of training completion criteria the WTRU stops training and returns the trained model to the network. The completion criteria may include one or more of the following: a difference between the estimated LOS indicator and reference LOS indicator is below a preconfigured threshold; a change between the estimated LOS indicator for consecutive occasions is below a preconfigured threshold; a threshold number of measurements have been collected (e.g., preconfigured input and associated outputs); a threshold number of measurements have been collected per class (e.g., LOS measurements); and/or that measurements have been collected for a preconfigured time duration (e.g., training performed for 100 minutes).

Examples of a trained model returned to the network may include: parameters of the trained ML model 1: model type—(e.g., Support Vector Machine); input features—(e.g., peak power, average power); output—(e.g., hard LOS values); kernel function—(e.g., Gaussian).

In some implementations, a WTRU may indicate to the network whether it can train a specific ML model (e.g., SVM). In such implementations, the network may select a model and define input measurements for the WTRU to perform training. (e.g., peak power, average power).

In some implementations, WTRU may indicate to the network that it is capable of training a ML model, without specifying model-specific capabilities. In some such implementations, the WTRU and the network interact as follows. The network may send more than one model (e.g., SVM, KNN and random forest) for NLOS identification. Based on hardware/implementation availability, the WTRU may select SVM for NLOS identification. The network may provide model details of the trained SVM for NLOS identification (e.g., input features, output, kernel type, kernel scale) to the WTRU.

In some implementations, a WTRU may receive a trained model from network. Examples of a trained model may include parameters used for a SVM. In some implementations, the WTRU measures channel impulse response from neighboring TRPs and applies these measurements to the trained model. In some implementations, the WTRU obtains LOS probability of each neighboring TRP. In some implementations, based on LOS probability of the different TRPs, the WTRU selects neighboring TRPs to transmit PRS and measure TDOA. In some implementations, TDOA measurements performed with LOS TRPs minimize positioning error.

In some implementations, a WTRU may indicate to the network that it is capable of ML based model training. In some such implementations, the WTRU receives a model, input type to the model, and output (e.g., desired output) of the model. In some implementations, the WTRU may choose one of the following as an input type to classify LOS/NLOS condition (obtained as output). Example preconfigured inputs may include, channel impulse response data (e.g., multiple taps where each tap is associated with relative delay with respect to the first tap and relative power with respect to the tap with the highest power); peak power (e.g., peak RSRP) data; average power (e.g., mean RSRP) data; peak to average power ratio data; skewness of channel impulse response data; and/or kurtosis of channel impulse response data.

In some implementations, the WTRU may choose a ML model to classify LOS/NLOS conditions. In some implementations, the ML model may include one of the following ML models: Support Vector Machine; Logistic Regression; K-nearest neighbors; Random Forest; Decision Trees; and/or Naive Bayes.

Some implementations include model selection for NLOS identification.

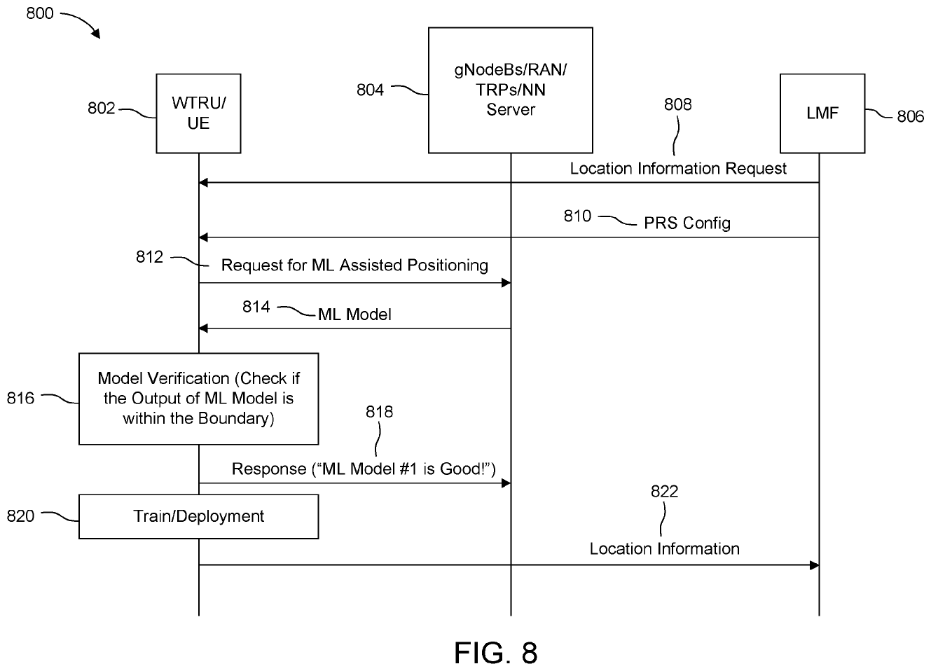

FIG. 8 is a message sequence chart 800 illustrating an example model selection procedure. In the example of FIG. 8, the WTRU or UE 802 (referred to generally as a WTRU 802) receives a location information request 808. The WTRU 802 receives a PRS configuration 810, e.g., from LMF 806. The WTRU 802 receives PRS from multiple TRPs (not illustrated). Based on predefined conditions, the WTRU sends ML assisted positioning request 812 to network device 804. The WTRU receives a ML model or models 814 for training and/or deployment, e.g., from network device 804. The WTRU performs verification and/or selection 816 to verify the ML model and/or select a ML model to perform training and/or deployment based on the coverage of the model. Examples of model coverage include geographical location of the WTRU, reference TRP, reference beam ID, NLOS environment only or Indoor environment. The WTRU in some implementations sends a notification 818 to network device 804 indicating the verification status and/or model selection at step 818, and performs training and/or deployment 820 of the model to determine location information, or for training purposes. In some implementations the WTRU returns an indication 822 of location information or a trained model to the network (e.g., to LMF 806).

Examples of configuration aspects associated with ML models, such as SVM models, are described herein. The term ML model is used to describe AI and/or ML models. The various examples and implementations described herein are not limited to these configuration aspects and/or the SVM model, which are exemplary, and are applicable to any attribute, property and/or characteristics associated with any ML model. For example, the configuration aspect of the model may include one or more of: dimensions of the model; a kernel type or configuration thereof; and/or a regularization parameter.

For model dimension configuration aspects, for example, the dimension configuration may include the input shape and/or input dimension, number of features, number of classes for classification, class labels, class weights etc. of the model.

For kernel type configuration aspects, for example, a kernel may refer to any function that takes as an input in a low dimensional space and transforms it to a higher dimensional space. In some solutions, the kernel may apply for classification involving non-linear decision boundary. For example, the kernel configuration may indicate a type of kernel, e.g., linear kernel, polynomial kernel, gaussian kernel, radial basis kernel etc. In some implementations, each kernel may include additional parameterization based on the type of the kernel.

For regularization parameter configuration aspects, for example, the regularization parameter may control tradeoff between overfitting (e.g., good model performance on training data set but poor performance during testing and/or deployment) and generalization (e.g., good model performance during testing and/or deployment). A relatively lower value of the regularization parameter may lead to reduced classification error (e.g., during training) at the expense of poor generalization (e.g., during deployment). A relatively higher value of the regularization parameter may lead to better generalization at the expense of some misclassifications.

In some implementations, a WTRU may be configured with one or more properties associated with the ML model and the WTRU may train the ML model based on one or more of the configured properties.

For example, in some implementations, a WTRU may receive a RRC configuration including at least one configuration aspect of an ML model associated with NLOS identification. For example, the configuration may include a type of ML model to use for NLOS identification. Example types of ML models include, SVM, Logistic regression, k-nearest neighbors, random forest, decision trees, naïve Bayes, etc. For example, the WTRU may be configured to apply an ML model (e.g., SVM ML model) for NLOS identification. In some implementations, the RRC configuration may include a configuration aspect of the model. In some implementations, the WTRU may apply the received configuration when training the model for NLOS identification. In some implementations, the WTRU may receive, as a configuration, a range of values (e.g., min and max value) for a specific parameter associated with model. In some implementations, the WTRU may choose a specific value within the preconfigured range. For example, the WTRU may be configured to input one or more aspects related to channel measurements, including but not limited to channel impulse response, peak power, average power, peak to average power ratio, skewness of channel impulse response, kurtosis of channel impulse response etc.

In some implementations, a WTRU may be configured to determine one or more properties and/or parameters associated with an ML model that meets a preconfigured criteria (e.g., a preconfigured training and/or deployment performance metric) and the WTRU may be configured to report one or more of the determined properties/parameters associated with the ML model.

For example, the WTRU may determine at least one configuration aspect of an model (e.g., an SVM model) trained for NLOS identification such that a preconfigured condition is met and may report the determined configuration aspect of the model. In some implementations, a preconfigured condition may include one or more of the following: a parameter (or parameter set) that minimizes training time for a given training data set, a parameter (or parameter set) that maximizes the classification accuracy, a parameter (or parameter set) that minimizes the of PRS overhead (or, equivalently, the size of training data), a parameter (or parameter set) that minimizes the inference time (e.g., maximizes number of inferences per second), and/or a parameter (or parameter set) that minimizes the input size, etc.

In some implementations, a WTRU may be configured with two (or more) ML models. In some implementations, the WTRU may use the output of one model to determine one or more aspects related to selection and/or configuration of the other ML model. In some implementations, the WTRU may apply the other ML model to obtain the WTRU position and/or a parameter thereof.

In some implementations, a WTRU may be configured with a first ML model, and a set of ML models and a condition to determine a ML model from the set of ML models for possible use as a second ML model. For example, the first ML model may be used for NLOS identification. Based on the output of first ML model, e.g., if NLOS condition is detected and if at least one ML model is configured, the WTRU may determine applicability of an ML model from the set of ML models to be used as a second ML model. If an applicable second ML exists, the WTRU may apply the second ML model for performing finger printing-based positioning. If an applicable second ML does not exist (e.g., there is no such model, or the model does not meet applicability criteria), then the WTRU may use a legacy positioning method. In some implementations, applicability criteria may include one or more of the following: whether the ML model is valid for the current geographical location, whether the performance of ML model is above a preconfigured threshold, whether the ML model inference latency is above a threshold etc. In some implementations, a WTRU may be configured with a first ML model, wherein the output of the first ML model may be used to choose input features and/or preprocessing inputs for the second ML model.

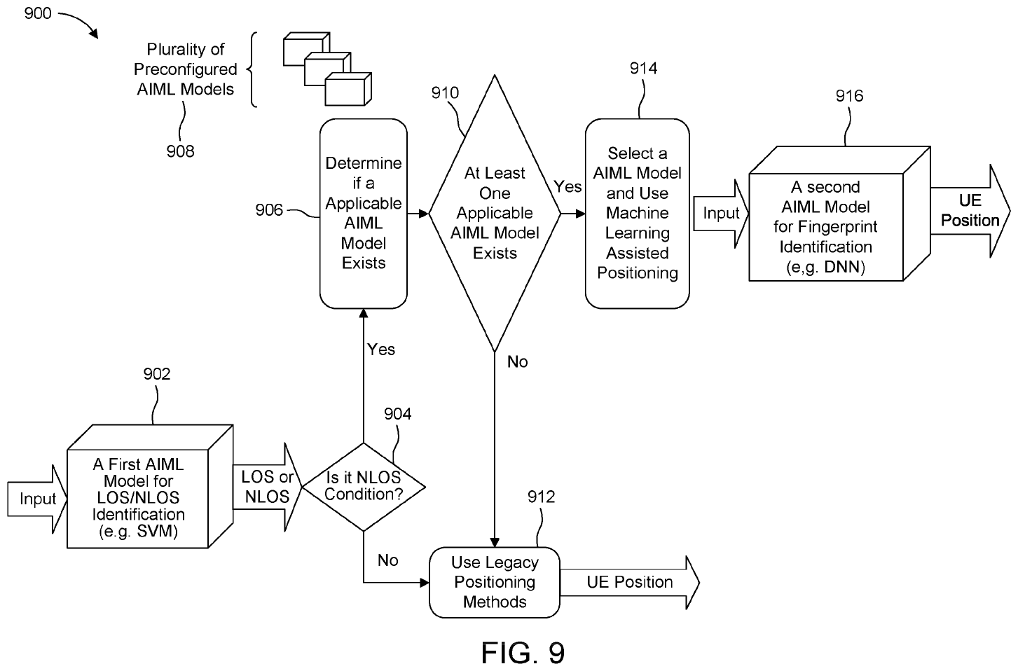

FIG. 9 is a flow chart 900 which illustrates an example procedure for determining a WTRU position using more than one ML model. In the example of FIG. 9, the WTRU receives an indication to identify the LOS/NLOS status for a TRP. The WTRU is configured with a positioning method (e.g., DL-TDOA). The WTRU determines LOS/NLOS conditions using the LOS/NLOS identification ML model at 902. On condition 904 that the path corresponding to the TRP is NLOS (904, yes), the WTRU determines if an applicable ML model exists at 906 from one or more models 908. On condition 910 that an applicable ML model is available at the WTRU (910, yes), the WTRU selects the model at 914 and applies the ML model for positioning at 916. On condition 910 that an applicable ML model is not available at the WTRU (910, no), the WTRU determines to use the configured positioning method at 912. On condition 904 that the path corresponding to the TPR is LOS (904, no), the WTRU determines to use the configured positioning method (e.g., DL-TDOA) at 912.

Some implementations include WTRU based training for NLOS identification. In some implementations, a WTRU may receive a model and/or parameters associated with the model for training. The WTRU may determine to train the model at the WTRU. The WTRU may receive a target output type (e.g., hard or soft LOS indicator) and an input type corresponding to the model (e.g., RSRP, channel impulse response measurements, RSTD), and may perform training as the WTRU receives and makes measurements on PRS. In some implementations, the WTRU may receive a PRS priority level from the network. In some implementations, the WTRU may receive a duration for training from the network. In some implementations, the WTRU may determine that training cannot be completed by the end of the duration, e.g., based on the PRS priority level. In some implementations, WTRU may request a training model that requires a shorter training duration, e.g., in response to determining that the training cannot be completed within a particular time (e.g., by the end of the duration).

The following example procedure is illustrative: The WTRU may receive a list of models (e.g., SVM, KNN) and criteria for training completion (e.g., minimum validation accuracy) for ML, from the network. The WTRU may receive a PRS priority level from the TRP. The WTRU may receive a timing of the first LOS/NLOS report (or LOS/NLOS reporting frequency), from the network. The WTRU may take measurements of PRS from the network. The WTRU may determine a model for LOS/NLOS classification based on the PRS priority and training time. In some implementations, if the priority level of PRS is low, the WTRU may not be able to process PRS as scheduled. If the training time of any models exceeds the timing of the first LOS/NLOS report and/or PRS priority level is low, the WTRU requests, from the network, a new set of models which require a shorter training time. If the training can be completed before the timing of the first report, the WTRU indicates the selected model. After completion of the training based on predefined criteria (e.g., after achieving a predefined validation accuracy), the WTRU may send a training completion notification and/or details of the trained model (e.g., kernel function) to the network.

Some implementations include WTRU assisted training for NLOS identification. In some implementations, a WTRU may return measurements taken of PRS to the network, which are used by the network for training performed by the network. The WTRU may receive an indication from the network to perform location estimation, e.g., such that the WTRU can report measurements and associated location estimation to the network. In some implementations, the WTRU may assist the network to collect measurements for NLOS identification. In some implementations, the WTRU may record these measurements.

Some implementations include WTRU based deployment for NLOS identification. For example, in some implementations, a WTRU may use a ML model to estimate a LOS indicator. In some implementations, the WTRU may receive an indication from the network to use the ML model to estimate the LOS indicator for an indicated PRS resource or resources, and/or TRP or TRPs. In some implementations, the WTRU may receive parameters related to the ML model (e.g., dimensions of the SVM model).

The following example procedure is illustrative: Based on predefined conditions (e.g., achieved positioning accuracy lesser than a threshold), a WTRU may send an ML assisted NLOS identification request to the network. The WTRU may send its capability information to the network. The WTRU may receive a list of trained models (e.g., SVM, KNN) and input features (e.g., peak power, average power) for AI/ML based NLOS identification from the network. The WTRU may receive PRS priority level from the TRP. The WTRU may take measurements of PRS from the network. The WTRU may determine a model for NLOS identification based on required number of NLOS estimations per second. If the NLOS estimation time of any models exceeds the maximum allowed NLOS estimation time, the WTRU may request, from the network, a new set of models which require shorter NLOS estimation time. If the NLOS estimation can be completed in time, the WTRU may indicate the selected model to the network. The WTRU may predict or identify NLOS and/or LOS TRPs using the AI/ML model. Based on predefined requirement for conventional positioning algorithm (e.g., minimum number of LOS TRPS>3), the WTRU may send a request to the network whether conventional positioning or ML model-based (e.g., fingerprinting) positioning should be performed. If the WTRU sends a request to network to use a conventional positioning technique, it may provide a set of (LOS) TRP IDs, for performing conventional positioning, to the network.

Some implementations provide WTRU assisted deployment for NLOS identification. In some implementations, the WTRU may provide assistance to the network to estimate the LOS indicator for PRS resource(s) or TRP(s). In some implementations, the WTRU may return measurements to the network such that the network can use the measurements to derive the LOS indicator.

Some implementations provide machine learning assisted positioning with fingerprinting. For example, a WTRU may be configured to deploy a machine learning model capable of converting a predefined input to positioning information (as output of the model). In some implementations, the set of inputs and outputs may be based on one or more of the following: WTRU RSRP measurements, WTRU SINR measurements, sensor data, imaging and/or video data, positioning information (e.g., GNSS or the like), inputs from the network including data and/or assistance information, outputs of positioning methods, etc.

In some implementations, an RSRP fingerprint is a unique sequence (e.g., unique, locally unique, or otherwise identifiable) of measured RSRP values from different transmitting sources. In some implementations, transmitting sources may be either different TRPs or different beams from the same TRP. In some implementations, RSRP fingerprints are unique per geographical location and WTRUs situated in same geographical location (e.g., within a threshold distance of one another, or within a defined boundary) record similar RSRP patterns. In some implementations, a machine learning model learns an RSRP fingerprint pattern per location during a training phase. In some implementations, during a deployment phase, the model receives an RSRP fingerprint as an input and estimates and/or predicts a position as output.

In some implementations, a fingerprint can include RSRP measurements based on PRSs transmitted from one or more TRPs. In one example, e.g., for a WTRU deployed in the mixed LOS/NLOS environment of FIG. 7, an example RSRP fingerprint (or fingerprints) may be of the following form: Per TRP RSRP Fingerprint for UE1: {TRP2: −90 dbm, TRP3: −72 dbm, TRP4: −68 dbm, TRP9: −75 dbm}. Per beam per TRP RSRP fingerprint for UE1: {TRP2_beam5: −99 dbm, TRP3_beam2: −80 dbm, TRP4_beam6: −82 dbm, TRP9_beam1: −75 dbm}. Per beam RSRP fingerprint for single TRP: {TRP4_beam1: −99 dbm, TRP4_beam2: −80 dbm, TRP4_beam3: −72 dbm, TRP4_beam4: −85 dbm}.

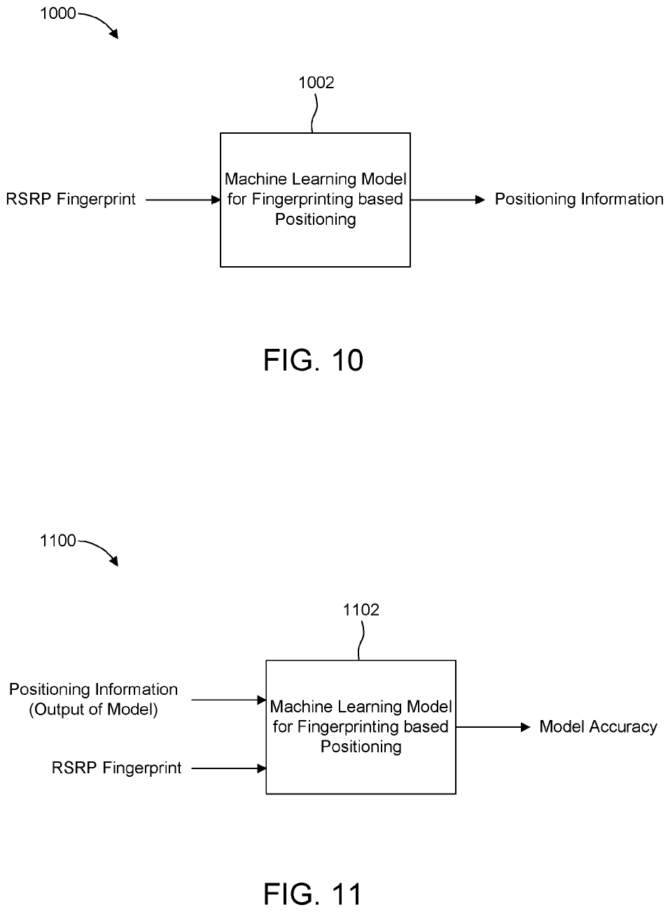

Some implementations include fingerprinting based positioning in deployment. For example, FIG. 10 is a block diagram 1000 illustrating an example model deployment procedure for fingerprinting-based positioning. In some implementations, a model 1002 may have a limited coverage (e.g., may be limited to a specific TRP, AMF and/or LMF) or limited to a specific environment (e.g., specific to an NLOS environment or NLOS TRPs). Model 1002 may include a trained neural network (NN), such as the network described above in connection with FIG. 6, or any other type or form of machine learning model, classifier, or predictor.

Examples of RSRP fingerprinting inputs may include one or more of the following: RSRP per PRS resource; RSRP per TRP; average RSRP per PRS resource; statistical measure of RSRP for PRS resource (e.g., standard deviation, variance); PRS resource ID; PRS resource set ID; locations of TRPs; boresight angle information of a PRS resource; PRS resource ID corresponding to the maximum or minimum RSRP for a TRP; and/or LOS indicator per TRP.

In some implementations, in addition or alternative to RSRP based fingerprinting, fingerprinting may be based on one or more of the following: TDOA per PRS resource; TDOA per TRP; TOA per PRS resource; TOA per TRP; RSRP per path per TRP; and/or RSRP per path per PRS resource. Fingerprint inputs may be provided to the model in any suitable form, such as an array, string, concatenated values with predetermined lengths, variable length values with separators, etc.

In some implementations, WTRU positioning information outputs may be represented, for example, in one or more of the following forms: Cartesian coordinates; spherical coordinates; GPS coordinates; and/or distance from a reference object.

In some implementations, a WTRU determines neighboring LOS TRPs. For example, if the available LOS TRPs are fewer in number than a preconfigured threshold (e.g., <3), the WTRU may send a request to the network to initiate fingerprint-based positioning. In some implementations, a WTRU determines that it can receive PRS only from one TRP. In some such situations, the WTRU sends a request to the network to initiate single-TRP based fingerprinting-based positioning.

Some implementations include model training for fingerprinting-based positioning. For example, in some implementations, a WTRU may indicate to the network that it is capable of training a ML model for fingerprinting-based positioning.

FIG. 11 is a block diagram 1100 illustrating an example model training procedure for fingerprinting-based positioning. In the example of FIG. 11, the WTRU may receive a model and RSRP fingerprint configuration as input. Model 1102 may include a trained neural network, such as the network described above in connection with FIG. 10, or any other type or form of machine learning model, classifier, or predictor. For example, the WTRU may receive the model and fingerprint configuration utilized in the implementation of FIG. 10. In this example, the WTRU is capable of determining its position (e.g., using GNSS based position determination, or sensor-based position determination). In another example, the WTRU may obtain RAT dependent positioning, e.g., during a training phase, e.g., as follows. In some implementations, e.g., based on a positioning method configured by the network (e.g., WTRU-based DL-TDOA, WTRU-based DL-AoD), the WTRU may obtain the estimated location information. In some implementations, the WTRU may evaluate positioning accuracy by comparing the estimated location information and the reference location information. After achieving a desired model accuracy, the WTRU may terminate the training and return the model to the network.

In some implementations, the WTRU may receive location points to cover for training purposes. For example, in some implementations, the WTRU moves to each location point (e.g., received from network) in the deployment area (e.g., 50 m radius from TRP1 with measurement density 10 measurements/square meter) and provides RSRP fingerprint measurements to the model during a training procedure.

Fingerprinting may include single TRP and/or multi-TRP fingerprinting. For example, in some implementations, a WTRU requests to train and deploy single TRP training. In some implementations, in single TRP training, all RSRP measurements are recorded from a single TRP. The WTRU may receive configurations from the network related to TRP, e.g., TRP ID. For example, based on the TRP ID, the WTRU may make measurements on PRS transmitted from the TRP with the TRP ID and train the ML model for fingerprinting.

In some implementations, in multi TRP fingerprinting, RSRP fingerprints are recorded from multiple TRPs. In some implementations, multi TRP fingerprinting provides a higher resolution of input data, which may result in a relatively complex machine learning model. In some implementations the WTRU may receive configurations from the network related to TRP, e.g., TRP ID(s). For example, based on the TRP ID(s), the WTRU may take measurements of PRS transmitted from the TRP(s) with the TRP ID(s) and train the ML model for fingerprinting.

Various criteria may be used to select the type of fingerprinting. For example, in some implementations, a WTRU requests single TRP training if it identifies that it can receive PRS from only one TRP. In some implementations, the WTRU requests single TRP training if the WTRU has limited computational capability and cannot process a complex machine learning model, e.g., due to hardware resource or processing delay limitations. In some implementations, the WTRU requests multi TRP training if the WTRU identifies that a limited number of RSRP measurements are available from a single TRP.

Some implementations include an exit condition for fingerprinting. For example, in some implementations, a WTRU may fall back to conventional positioning based on predefined fallback criteria (e.g., if achieved positioning accuracy is less than a threshold, if a number of visible LOS TRPs are less than a threshold, etc.)

In some implementations, conventional positioning refers to positioning that does not rely on a model which requires training. In some implementations, conventional positioning may include measurements (e.g., RSRP, RSTD, AoA, AoD) and the WTRU and/or network may determine location information based on linear or non-linear processing of the measurements. Examples of conventional positioning include DL-TDOA, DL-AoD, Multi-RTT, UL-TDOA, UL-AoA.

Some implementations include WTRU based training for positioning with fingerprinting. For example, In some implementations, a WTRU may determine a validity condition of a trained ML model, during training. In some implementations, before the training phase is initiated, the WTRU determines a method to determine its location. In some implementations the WTRU may be configured with a RAT dependent (e.g., DL-TDOA) or RAT independent (e.g., GNSS) positioning method.

In some implementations, depending on the configured positioning method, the number of TRPs configured for the WTRU may vary. For example, in some implementations, the WTRU may be configured with more than one TRP if the WTRU is configured with a conventional RAT-dependent positioning method (e.g., DL-TDOA). In some implementations, if the WTRU is configured with a RAT independent positioning method, the WTRU may be configured with one TRP for training the ML model. In some implementations, during the training, the WTRU may use measurements made on PRS, transmitted from configured TRP(s), as input to the ML model and use the determined location from RAT dependent/independent positioning method as the target. In some implementations, after the training is completed (e.g., after the timer reaches the training duration, or a time window during which the WTRU performs training expires), the WTRU determines validity for the ML model. The validity for the ML model may be represented in terms of, for example, area validity, time validity, and/or accuracy validity.

In some implementations, for area validity, for example, the WTRU may determine to associate TRP ID(s) with the ML model such that the WTRU or network can use the ML model when the WTRU is located close to the TRP(s) associated with the TRP ID(s). In some implementations, for time validity, for example, the WTRU may determine the duration during which the WTRU can use AI/ML model for location estimation. The WTRU may determine time validity for the ML model based on the training duration or measurement conditions (e.g., RSRP of PRS). In some implementations for accuracy validity, for example, the WTRU may associate confidence level or indicator which indicates trustworthiness of the trained ML model. The WTRU may be preconfigured with a table which associates the confidence level and RSRP of PRS. For example, the WTRU may determine that low RSRP is associated with low confidence level.

In some implementations, if the WTRU is configured with more than one TRP, the WTRU may determine to associate TRP(s) with the ML model from which the WTRU receives PRS with RSRP above a preconfigured threshold. In some implementations, if the WTRU is configured with one TRP, the WTRU may determine to associate the TRP with the ML model.

The following example procedure is illustrative: The WTRU may determine a method to derive its location (e.g., WTRU-based RAT dependent methods, GNSS, WiFi) based on availability and/or WTRU capability. If the WTRU has an available method to determine its location, the WTRU may indicate to the NW (e.g., via signaling, WTRU capability) that the WTRU has the capability to train ML models. The WTRU may receive a PRS configuration (e.g., a list of TRPs from which the WTRU receives PRS) from the NW and may receive an indication to conduct ML training. If the WTRU indicates RAT dependent positioning method to derive its location, more than one TRPs may be configured. If the WTRU indicates RAT independent positioning method, one TRP may be configured by the TRP. The WTRU may request a training window (e.g., MG). The WTRU may receive the window config from the NW. During the window, the WTRU may receive PRS and may process measurements obtained from received PRS (e.g., RSRP, RSTD, AoA, AoD, ToA) and trains ML model(s) with the determined WTRU location. After the window expires, the WTRU may determine a validity condition for trained ML models(s) based on measurement conditions (e.g., duration of granted window, amount of measurements corrected, RSRP statistics such as average RSRP, frequency information, e.g., frequency layer, FR1/FR2, BWP, band, method used to determine its location) where validity condition may be expressed in terms of time and/or associated TRP. If the WTRU is configured with multiple TRPs, the WTRU may determine the TRP associated with the trained ML model based on the number of beams with RSRP above the threshold. If the WTRU is configured with one TRP, the WTRU may determine to associate the configured TRP with the ML model.) The WTRU may return weights for ML models to the NW, and, e.g., associated validity, associated TRP, and the method used to train ML models, confidence interval (also possibly timestamp when training is completed or timestamp indicating when weights for ML models are sent) etc. . . .

The following example procedure for WTRU-based position determination, multi-TRP training, is illustrative: The WTRU may receive PRS configurations from the NW The WTRU may request a window. The WTRU may receive the window configuration from the NW. The WTRU may determine the validity area to which the WTRU belongs, based on the determined location. The WTRU may train a ML model with measurements made from the TRPs in the area validity. The WTRU may associate the validity area with the trained ML model. The WTRU may return a trained ML model to the NW, and may return an associated validity and/or the method used to train ML model.

Some implementations include WTRU assisted training for positioning with fingerprinting. For example, in some implementations, a WTRU may return measurements taken of PRS to the network for WTRU assisted training for fingerprinting based positioning. Examples of measurements may include RSRP, RSTD, AoA, etc.

Some implementations include WTRU based deployment for positioning with fingerprinting. For example, in some implementations, a WTRU may determine the ML model based on the target TRP. The WTRU may determine the target TRP based on measurements made on PRS (e.g., RSRP). The WTRU may determine whether the granted or available ML model at the WTRU is associated with the target TRP. If at least one of the ML models is associated with the target TRP, the WTRU may determine to use the ML model to estimate its location.

The following example procedure is illustrative: The WTRU may receive PRS configurations from the NW. The WTRU may request ML model(s) corresponding to the configured TRPs from the NW. The NW may grant trained ML model(s) to the WTRU and their validity conditions. The WTRU may determine the target TRP based on RSRP of PRS transmitted from TRPs (e.g., the strongest RSRP, RSRP above the threshold). Based on the validity conditions for the trained ML model(s): a. If the WTRU has a valid ML model for the target TRP, the WTRU may determine its position using the ML model. If the WTRU does not have a valid ML model for the target TRP, the WTRU may determine to send a request to the NW to configure a positioning method (e.g., DL-TDOA, DL-AoD) and initiates a positioning method.)

If one or more preconfigured or granted ML model(s) are associated with more than one TRP, the WTRU may determine in which zone the WTRU is located. In some implementations, the WTRU may determine the zone based on RSRP measurements of the configured PRS.

The following example procedure is illustrative: The WTRU may receive PRS configurations from the NW. The WTRU may request ML model(s), e.g., with associated zones, and e.g., relationships between zones and TRPs. The NW may grant trained ML model(s) to the WTRU and may provide their validity conditions. The WTRU may determine the target zone, e.g., based on RSRP of PRS transmitted from TRPs (e.g., the strongest RSRP, RSRP above the threshold). Based on the validity conditions for the trained NN(s): If the WTRU has a valid NN for the target zone, the WTRU may determine its position using the NN. If the WTRU does not have a valid NN for the target TRP, the WTRU may determine to send a request to the NW to configure a positioning method (e.g., DL-TDOA, DL-AoD) and may initiate a positioning procedure.

Some implementations provide WTRU assisted deployment for positioning with fingerprinting. For example, in some implementations, in WTRU assisted deployment for fingerprinting-based positioning, the WTRU may provide the target TRP to the network such that the network can determine which ML model to use. The WTRU may determine the target TRP based on measurements made on PRS.

The following procedure is exemplary: The WTRU may receive PRS configurations from the NW. The WTRU may determine the target TRP based on RSRP of PRS transmitted from TRPs (e.g., the strongest RSRP, RSRP above the threshold). The WTRU may send metadata for model selection (e.g., the metadata may include a set of data which provides additional information about the WTRU which is relevant for model to make a decision) to the network which may include one or more of the following: assistance Information: (e.g., TRP Id, LOS/NLOS condition with TRP, velocity) and/or model selection criteria (e.g., power requirements (low complexity model for low power WTRUs), criticality, required accuracy, prior positioning method, etc. The NW may grant trained ML model(s) to the WTRU and its validity conditions. Based on the validity conditions for the trained NN(s): If the WTRU has a valid ML model(s) for the target TRP, the WTRU may determine its position using the NN, or if the WTRU does not have a valid ML model(s) for the target TRP, the WTRU may determine to send a request to the NW to configure a positioning method (e.g., DL-TDOA, DL-AoD) and initiate a positioning method.)

Some implementations include model monitoring and updating for positioning enhancements. For example, in some implementations, multiple ML models (e.g., for NLOS identification and/or fingerprint based positioning) may have been trained with each model optimized for a special condition or use case (e.g., model specific to a TRP, group of TRPs, set of beams, NLOS environment, indoor factory environment, coverage of a single TRP, WTRU computational capability etc.). The WTRU may receive a validity condition of the model after downloading the model. While in deployment phase, the WTRU may periodically monitor the validity conditions associated with the model.

Some implementations relate to model validity. For example, in some implementations, a WTRU may receive a set of ML model(s) (e.g., for NLOS identification and/or fingerprint-based positioning) of trained models with each model's optimization criteria. The WTRU may identify a suitable criterion or criteria and request a corresponding model (e.g., a model optimized for NLOS environment) to the network. In some such situations, the WTRU receives a single trained model with requested criteria. In some implementations, after receiving the trained model, the WTRU may use it until validity criteria for the model are fulfilled or the model is no longer valid.

Some implementations relate to model monitoring. For example, in some implementations, a WTRU may receive an ML model and associated timing-based validity criteria. The WTRU may receive a model with its validity based on future timestamp information. In some implementations, if the validity timestamp is exceeded (or a desired time elapses), the WTRU receives a new model or switches to a conventional positioning technique.

In some implementations, a WTRU may receive a ML model and associated condition-based validity criteria. The WTRU may periodically monitor a condition associated with the model (e.g., ref TRP ID, beam ID, Number of LOS TRPs, model accuracy etc.), and the WTRU periodically monitor the validity criteria. The WTRU may notify the network if the selected model is no longer valid.

Some implementations relate to model updating. For example, in some implementations, a WTRU may update and/or swap the ML model and may download a new ML model along with training and/or deployment specific performance metrics. In some implementations, the model update may be followed by a model monitoring procedure. In some implementations, depending upon the location of trained model, the WTRU may receive the update from TRP, LMF or a locally (within the WTRU) trained model.

Some implementations include an indication of a trained model upon or when entering or exiting an area. For example, in some implementations, the WTRU may transmit an indication of a ML model and associated parameters upon detecting that it is entering (or exiting) an area over which such model is trained. For example, the detection may be based on determining that a measurement metric (such as RSRP) is higher than a threshold for a specific cell or for a specific set of cells. In another example, the detection may be based on the identity of a serving cell in connected, inactive or idle mode. In such case, the WTRU may initiate transmission of the indication upon handover (RRC configuration with mobility) and/or cell reselection from/to the serving cell. The identity of a serving cell may include at least one of a general cell identifier, a physical cell identity and/or carrier frequency. The WTRU may have determined the measurement threshold and set of cell(s) during prior use of the model.

In some implementations, the WTRU may include one or more of the following information in the indication: an identifier for the trained model; an identifier for the WTRU; and/or at least one indication of a positioning measurement configuration that may be used with the trained model.

In some implementations, the indication of a positioning measurement configuration may include at least one property for at least one positioning resource, such as a carrier frequency, a periodicity, a frequency range and/or a bandwidth part. In some implementations, the indication may include a periodicity for the measurement reports. In some implementations, the indication may include separate indications for each such property, or of a single label indicating one of a set of possible positioning measurement configurations. In some implementations, the WTRU may previously have received a configuration for the identifier of a trained model and at least one label for at least one positioning measurement configuration by signaling (e.g., RRC and/or LPP) for example during earlier use of the trained model.

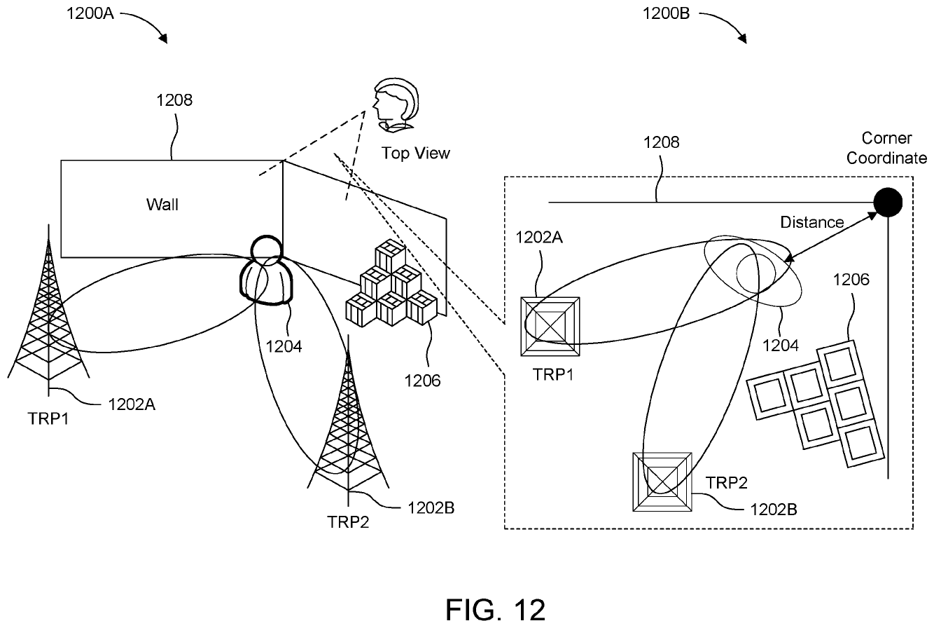

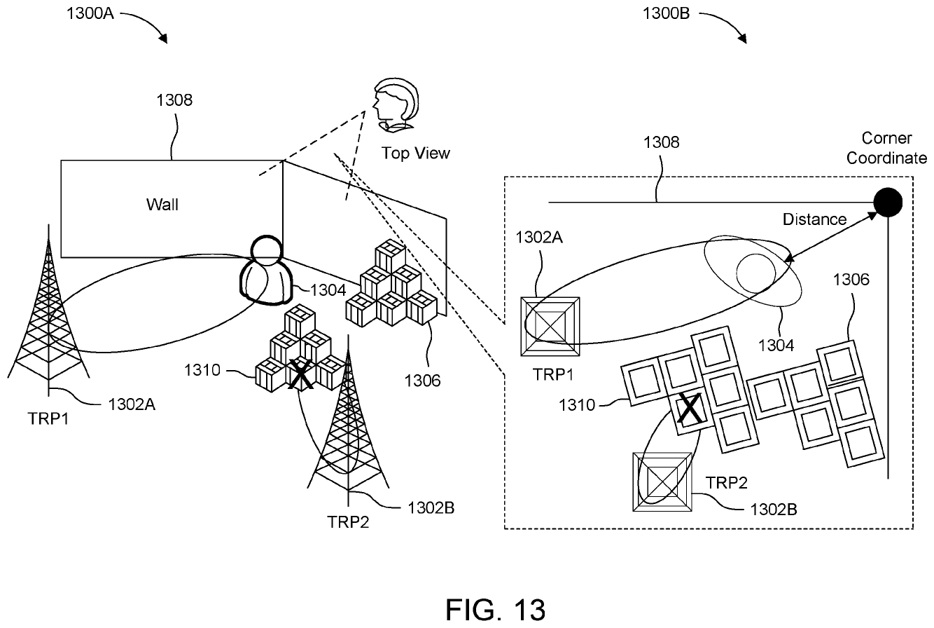

Some implementations relate to adaptive hybrid positioning (e.g., positioning technique selection). In some situations it may be more practical for a WTRU to apply a ML assisted positioning method than to apply a non-ML positioning method, e.g., due to the positioning accuracy achievable by each method. Some example cases where it may be more practical for a WTRU to apply a ML assisted positioning method include where the WTRU is on the edge of a room (e.g., on the edge of a factory hall), and it is in LOS with 2 TRP (e.g., as illustrated in FIG. 12) and/or where the WTRU is on the edge of a room (e.g., on the edge of a factory hall) and it is in LOS with 1 TRP (e.g., as illustrated in FIG. 13). In some implementations, if a non-ML positioning technique is applied to both WTRUs (e.g., as shown in FIGS. 12 and 13), positioning accuracy may be degraded (e.g., with respect to a corresponding ML-based technique), e.g., due to a lack of a sufficient number of TRPs available to locate the WTRU at the corner of a room, or due to the presence of an obstacle (e.g., blocking one or more TRPs).

In some situations (e.g., due to different environmental factors and/or TRPs location with respect to the WTRU) a WTRU may encounter degradation in positioning accuracy after applying non-ML positioning techniques. In some cases however, it may not be practical to implement a ML-assisted positioning method, e.g., due to practical limitations (e.g., unavailability of a trained ML model, a power consumption limitation of the WTRU, a hardware limitation of the WTRU, etc.). It is noted that non-ML and ML-assisted positioning methods may include more than one method. For example non-ML positioning include DL-TDOA, AoD etc. and ML-assisted positioning technique include single-TRP positioning, multi-TRP positioning etc.

In some situations, e.g., due to the WTRU's position, different positioning techniques and/or sub-techniques (e.g., single TRP positioning vs. multi TRP positioning in the case of ML-assisted positioning, or timing-based vs. angle-based positioning for non-ML positioning) may lead to different achievable positioning accuracy. Accordingly, in some implementations, selection of a preferable or optimal positioning method may be desired.

FIG. 12 includes a perspective 1200A and plan 1200B view of an example deployment of a WTRU 1204 at the corner of a deployment area 1208 with 2 LOS TRPs 1202A-1202B. The environment or deployment area may include an obstacle 1206 that may not necessarily interfere with signals from TRPs 1202A-1202B, such that they can provide LOS signals. FIG. 13 includes a perspective 1300A and plan 1300B view of an example deployment of a WTRU 1304 at the corner of a deployment area 1308 with 1 LOS TRP 1302A. Non-LOS TRP 1302B may be blocked by an obstacle such as obstacle 1310 such that TRP 1302 cannot provide LOS signals (though non-LOS paths may exist).

In some implementations, e.g., to address aforementioned problems, a hybrid approach (e.g., a two-step adaptive hybrid positioning approach between non-ML positioning techniques and ML assisted positioning techniques) may be implemented. In some implementations, the hybrid approach includes position estimation of the WTRU, and selection of positioning technique by the WTRU. For example position estimation can be done by WTRU based on the measurements made by the WTRU.

In some cases, techniques described herein may be referred to as “adaptive hybrid” in that they may use either ML-assisted or non-ML-assisted positioning depending on circumstances. In some implementations, whether to use ML-assisted or non-ML-assisted positioning may be based on an estimate of the position of the WTRU (e.g., combined with other predefined conditions) to obtain the WTRU's position.

In some implementations, position estimation (e.g., determination of an initial estimated position, or coarse position of the WTRU) can be derived using non-ML assisted position estimation or ML assisted position estimation.

In some implementations, the positioning technique used by the WTRU to determine its location is selected based on predefined conditions received by the WTRU (e.g., a threshold number of LOS TRPs, a threshold location of TRPs with respect to the WTRU, and/or an availability of a trained ML model for a WTRU for a coarse location, etc.) associated with each positioning method from the network (e.g., from an LMF). In some implementations, the WTRU applies and/or selects a corresponding positioning technique to determine its location based on fulfillment of specific condition and position estimation criteria (e.g., obtained during position estimation).

In some implementations, a WTRU may be configured to apply position estimation e.g., to determine position estimation information based on predefined input criteria. Example inputs may include one or more of the following examples: WTRU RSRP measurements, WTRU SINR measurements, TOA measurements, TDOA measurements, sensor data (e.g., from radar sensors, from LIDAR sensors), imaging data/video data, positioning information from the GNSS, etc. Output of the position estimation technique may include an estimated position, and may include, for example, absolute cartesian coordinates, relative cartesian coordinates, polar coordinates, absolute cartesian coordinate with margin of error, Zone ID (e.g., where the network divides a deployment area in Zones, such that each sub deployment area, also known as a Zone, has a unique (or locally unique) identifier which may be referred to as a Zone ID, and where the WTRU has a preconfigured mapping between Zone ID and geographical area.), etc.

In some implementations, a WTRU may be configured to apply ML-assisted position estimation. For example, in some implementations, a WTRU may be configured to deploy a ML model. In some implementations, the ML model may be configured to convert a predefined input (e.g., an RSRP fingerprint) to positioning estimation information (e.g., a Zone ID).

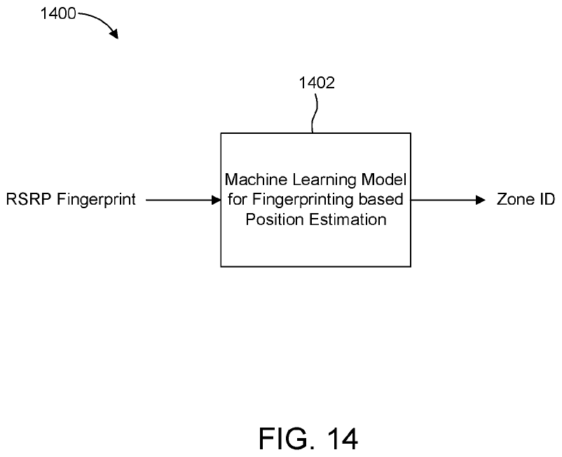

FIG. 14 is a block diagram 1400 illustrating a input and output for an example ML-assisted position estimation implementation using Zone IDs and a model 1402. Model 1402 may include a trained neural network, such as the network described above in connection with FIG. 6, or any other type or form of machine learning model, classifier, or predictor.

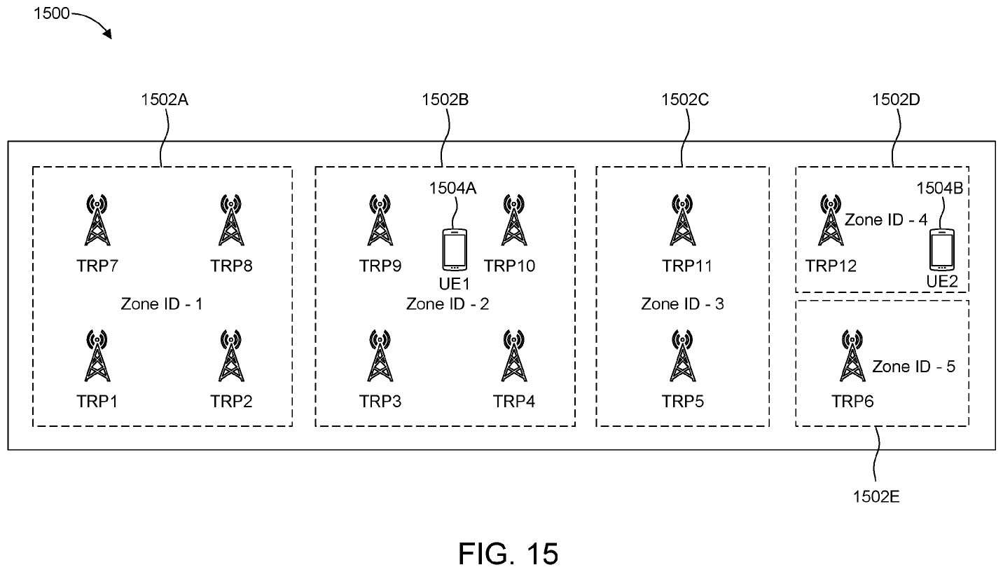

FIG. 15 is a block diagram 1500 illustrating an example ML-assisted position estimation scenario. In this example, the deployment area is divided into 5 zones 1502A-1502E, where each zone has a unique (e.g., locally unique) Zone ID (e.g., Zone ID-1, Zone ID-2, . . . , Zone ID-5). In some implementations, for each location in the deployment area, there exists at least one associated zone. In some implementations, the WTRU 1504A (UE1 in the figure), 1504B (UE2 in the figure) receives a trained ML model (e.g. model 1402 of FIG. 14), which can convert RSRP fingerprint measurements to Zone ID of a zone where the WTRU is located. In this example, the RSRP fingerprint measurements are an input to the model, and the Zone ID is an output of the model. In some implementations, ML-assisted position estimation for WTRUs in the example of FIG. 15 may be as follows:
RSRP fingerprint for UE1 1504A: {TRP9: −90 dbm, TRP10: −91 dbm}, Zone Id estimation for UE 1:2 (1502B).
RSRP fingerprint for UE2 1504B: {TRP12: −90 dbm, TRP6: −95 dbm}, Zone Id estimation for UE 2:4 (1502D).

Some implementations include WTRU-based training with coarse location information for ML assisted position estimation. For example, a WTRU may indicate to the network that it has the capability to train an ML model for fingerprinting-based positioning estimation.

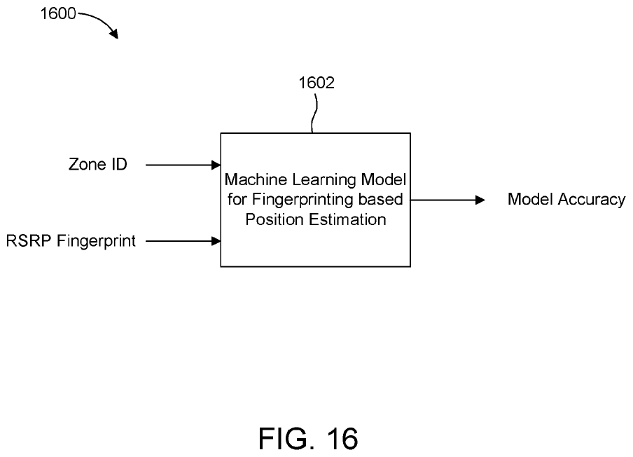

FIG. 16 is a block diagram 1600 illustrating an example training procedure for ML assisted position estimation. In this example, the WTRU receives a model and an RSRP fingerprint configuration. The WTRU also receives a mapping for a first coarse position to Zone ID conversion.

In some implementations, the WTRU is capable of determining its first coarse position (e.g., using GNSS based position determination, or sensor-based position determination) or the WTRU may obtain RAT-dependent positioning during a training phase, e.g., as follows. In some implementations, e.g., based on a positioning method configured by the network (e.g., WTRU-based DL-TDOA, WTRU-based DL-AoD, etc.), the WTRU may obtain estimated location information. The estimated location information may be expressed in terms of coordinates (e.g., in terms of global coordinate system coordinates, or a local coordinate system). The term “coarse position” may be used interchangeably with “location information” in the examples described herein.

In some implementations, e.g., for WTRU-based training, the WTRU receives a mapping between zones and positions from the network. By applying the configured mapping between coarse position and Zone ID, the WTRU may obtain its Zone ID and provide it as the target for the model during training. For example, the WTRU may derive the coarse position based on measurements (e.g., RSRP) using a positioning method (e.g., DL-TDOA, DL-AoD). Based on the configured mapping, the WTRU may determine the zone ID corresponding to the coarse location. The Zone ID may be labeled as the target for training the ML model. Thus, for each set of measurements (e.g., RSRP, RSTD, RTT, AoA, AoD), there may be a corresponding zone ID as the target for training. The ML model may be trained, for example, on N sets of measurements with corresponding N zone IDs. The ML model may be trained such that given a set of measurements, the ML model generates the zone ID which corresponds to the set of measurements. For example, if the ML model is given a set of RSRP measurements [−50 dBm, −40 dBm, −30 dBm] corresponding to RSRP for 3 beams transmitted from a TRP, and corresponding zone ID is “3” (target), the WTRU may expect the trained ML model to generate the ID number “3” if RSRP measurements close to [−50 dBm, −40 dBm, −30 dBm] are input to the trained ML model. Alternatively, if the WTRU inputs [−50 dBm, −50 dBm, −50 dBm] and target zone ID “2” to the ML model during training, the WTRU may expect the trained ML model to generate ID number “2” when RSRP measurements close to [−50 dBm, −50 dBm, −50 dBm] is presented to the trained ML model. Training an ML model may require adjustment of internal parameters of the model (e.g., adjustment of weights used in the model). The measurements may include information related to multiple paths (e.g., RSRP per path, RSTD per path, time difference per path, AoA per path, AoD per path, etc.). In some implementations, the WTRU may also or instead use the coarse position itself as a target to train the ML model for ML assisted position estimation. In some implementations, if the WTRU does not receive a mapping from the network, the WTRU determines to use the coarse location (e.g., obtained from RAT dependent positioning, GNSS, sensor) as the target for training.

In some implementations, the WTRU terminates training (e.g., after a desired model accuracy is achieved) and may return the model to the network, e.g., for other WTRUs to use.

Some implementations include network-based training with coarse location information for ML assisted position estimation. In some implementations, the WTRU receives trained ML models from the network. In some implementations, the WTRU receives information related to configuration for the trained ML model, which may include information indicating whether the ML model is trained with zone ID or coarse location as the target.

Some implementations include a trigger condition for the WTRU to initiate adaptive hybrid positioning. In some implementations, the WTRU may send a request to the network to enable adaptive hybrid positioning (e.g., to the LMF). In some implementations, the request is sent based on one or more of the following example trigger conditions: that the WTRU is capable of performing both non-ML positioning and ML assisted positioning; that an accuracy requirement is not met by non-ML positioning; and/or that the WTRU determines that measurements used for non-ML positioning include errors.

In some implementations, the WTRU may monitor fluctuations in PRS-RSRP and/or RSTD measurements from a each TRP, and may identify fluctuations in those measurements (e.g., fluctuations in measurements from the same TRP) above or below a preconfigured threshold (e.g., a threshold standard deviation, variance, and/or maximum or minimum value of the measurements) as measurements with errors.

In some implementations, the WTRU may determine whether it is in a corner of the deployment area (e.g., based on the zone ID associated with a position in a corner) and/or may take an action based on whether it is in a corner of the deployment area (e.g., based on the zone ID associated with a position in a corner).

In some implementations, the WTRU may determine whether computational complexity of machine learning assisted positioning is higher than a predefined threshold, and/or may take an action based on whether computational complexity of machine learning assisted positioning is higher than a predefined threshold.

In some implementations, the WTRU may be configured with a maximum allowable ML model complexity (e.g., a maximum number of FLOP (Floating Operations) needed to perform positioning, and the WTRU may determine whether a trained ML model received by the WTRU has computational complexity higher than this threshold value. In some implementations, the WTRU may initiates adaptive hybrid positioning based on the trained ML model received by the WTRU having a computational complexity that is higher than a threshold value.

In some implementations the WTRU may determine whether it has been performing machine learning assisted positioning for a duration that is longer than a predefined threshold and/or may take an action based on whether it has been performing machine learning assisted positioning for a duration that is longer than a predefined threshold.

In some implementations the WTRU may be configured to perform ML assisted positioning (of a fixed or maximum computational complexity) for a predefined maximum time duration. In some implementations, if generation of an inference (e.g., of an estimated location) by the ML model takes longer than the predefined threshold, the WTRU may initiate adaptive hybrid positioning.

Some implementations include a condition associated with ML assisted positioning. In some implementations, a WTRU may apply one or more criteria to select a specific ML assisted positioning technique. For example, in some implementations, the WTRU may use a specific ML assisted positioning technique based on whether a LOS probability of each TRP is at or above (or below) a threshold, e.g., as configured by the LMF. In some implementations, the WTRU may use a specific ML assisted positioning technique based on whether an RSRP value of each TRP is at or above (or below) a threshold, e.g., as configured by the LMF

In some implementations, the WTRU may use a specific ML assisted positioning technique based on whether all the subjected TRPs are in one direction with reference to WTRU's estimated location. In some implementations, a WTRU is configured or preconfigured with valid Zone IDs and assistance information per Zone ID (e.g., indicating whether the Zone is located in the corner of the deployment area, whether a trained ML model is available for the Zone, etc.) In some implementations, if a WTRU maps its coarse or estimated position to a Zone ID which is in a corner, it may determine that all TRPs are in one direction from its position.

One such example scenario, based on the example deployment illustrated by FIG. 15, may include where both WTRUs receive a Corner Zone ID-{4,5}. After obtaining location estimation from phase 1 (i.e., location estimation), a first WTRU (UE1) may estimate that it is in Zone 2, and that Zone 2 is not in the corner of the deployment area. However, a second WTRU (UE2) may identify that its location estimation corresponds to Zone ID 4 and accordingly identify that it is located in Zone 4. Since Zone 4 is a corner Zone ID, the second WTRU may identify that all TRPs are located in one direction (e.g., within a 180 degree arc) with reference to its position.

In some implementations, a WTRU may receive information indicating corner coordinates of a deployment area and a corner detection distance. If the difference between the WTRU's location estimation and one of the corner coordinates is less than the corner detection distance, the WTRU may identify that it is located in a corner of the deployment area.

In some implementations, a trained ML model is available for the coarse position of the WTRU to perform ML assisted positioning. For example, using the example deployment of FIG. 15 for illustration, in some implementations, a trained ML model may be available for Zone ID-1, Zone ID-2, Zone ID-3 and Zone ID-4. In this example, a trained ML model for Zone ID-5 is not available (e.g., due to inadequate training). In some implementations, the WTRU is preconfigured with a model availability flag or other indication. In this example, a model availability flag for Zone ID-1, Zone ID-2, Zone ID-3 and Zone ID-4 may be set to true (e.g., to binary 1) and an availability flag for Zone ID-5 may be set to false (e.g., to binary 0).

The following example implementations illustrate techniques described herein. The order of the various steps are exemplary, and may be rearranged in any suitable way, or may include any suitable additional steps, and/or may omit some steps in any suitable way.

One example implementation includes WTRU-based Zone ID-aware adaptive hybrid positioning. In some implementations, the WTRU is configured by the network to perform adaptive hybrid positioning. In some implementations, the WTRU receives a trained ML model for ML-assisted position estimation, a trained ML model for ML assisted positioning, and TRP locations and associated LOS/NLOS indicators from the network. In some implementations, the WTRU receives a threshold value for a number of LOS TRPs needed for multi-TRP ML assisted positioning. For example, in some implementations, a threshold value for a number LOS TRPs needed for multi TRP ML assisted positioning=2. In some implementations, the WTRU receives an indication of all valid Zone IDs and assistance information per Zone (e.g., an indication of IDs for zones in corners may be expressed as Corner Zone ID-{4,5}). In some implementations, the WTRU is configured with a RAT-dependent non-ML positioning method (e.g., DL-TDOA). In some implementations, the WTRU takes measurements on PRS. In some implementations, the WTRU provides one or more of the measurements (e.g., RSRP) to the ML assisted position estimation model and obtains a Zone ID from the model based on the one or more measurements.

In some implementations, the WTRU makes the following determination related to positioning: If the WTRU determines that it is in a corner, e.g., based on its estimated Zone ID and assistance information, the WTRU determines to use ML assisted positioning (e.g., if the WTRU determines that it is in the Zone ID-4). If the WTRU determines that it is in a corner, e.g., based on its Zone ID and assistance information, and the number of TRPs with LOS indicator is equal or above the threshold, the WTRU determines to use a multi-TRP fingerprinting technique and returns estimated location. (e.g., if a number of visible LOS TRPs by the WTRU is greater than or equal to the threshold value of number LOS TRP for multi TRP ML assisted positioning). If the WTRU determines that it is in a corner, e.g., based on its associated Zone ID and assistance information, and the number of TRPs with LOS indicator is below the threshold, the WTRU determines to use a single TRP fingerprinting technique and returns its estimated location (e.g., number of visible LOS TRPs by the WTRU is less than the threshold value of number LOS TRP for multi TRP ML assisted positioning). If the WTRU determines that it is not located in a corner, e.g., based on associated Zone ID and assistance information, the WTRU determines to use the configured RAT-dependent non-ML positioning method. In some implementations, the WTRU returns its estimated position to the LMF.

One example implementation includes WTRU-based ML-assisted location estimation aware-adaptive hybrid positioning. In some implementations, the WTRU is configured by the network to perform adaptive hybrid positioning. In some implementations, the WTRU receives a trained ML model for ML-assisted position estimation, ML assisted positioning, and TRP locations and associated LOS/NLOS indicators from the network. In some implementations, the WTRU receives a threshold value for a number LOS TRPs needed for multi TRP ML assisted positioning. For example, in some implementations, a threshold value for a number LOS TRPs needed for multi TRP ML assisted positioning=2. In some implementations, the WTRU receives an indication of coordinates of corners of the deployment area and a threshold distance from the corners for corner detection. In some implementations, the WTRU is configured with a RAT-dependent non-ML positioning method (e.g., DL-TDOA). In some implementations, the WTRU takes measurements on PRS.

In some implementations, the WTRU provides one or more of the measurements (e.g., RSRP) to the ML assisted position estimation model and obtains its location estimation from the model based on the one or more measurements. In some implementations, the ML model deployed to obtain an interim or intermediate position estimation provides significantly lower target positioning accuracy (e.g., in order of 10 m) compared to the ML model deployed to estimate final position of the WTRU (e.g., in order of 0.1 m).

In some implementations, the WTRU makes the following determination related to positioning: If the WTRU determines that it is in a corner, e.g., based on the difference between the WTRU location estimate and one of the corner coordinates being below the threshold corner detection distance, the WTRU determines to use a ML assisted positioning method. If the WTRU determines that it is in a corner and that the number of TRPs with a LOS indicator is equal or above the threshold, the WTRU determines to use a multi-TRP fingerprinting technique and returns an estimated location. If the WTRU determines that it is in a corner and that the number of TRPs with a LOS indicator is below the threshold, the WTRU determines to use a single-TRP fingerprinting technique and returns an estimated location. If the WTRU determines that it is not located in a corner, e.g., based on the minimum value of differences between the WTRU location estimate and all the corner coordinates being above the threshold, the WTRU determines to use the configured RAT dependent non-ML positioning method.

In some implementations, the WTRU returns its estimated position to the LMF. In another example, the WTRU returns its estimated position and reports the positioning method used to determine the estimated position to the LMF.

Some implementations include WTRU-based non-ML location estimation aware-adaptive hybrid positioning. In some implementations, the WTRU is configured by the network to perform adaptive hybrid positioning. In some implementations, the WTRU receives a trained ML model for ML assisted positioning, TRP locations and associated LOS/NLOS indicators from the network. In some implementations, the WTRU receives a threshold value for a number of LOS TRPs required for multi TRP ML assisted positioning. For example, in some implementations, a threshold value for a number of LOS TRPs needed for multi TRP ML assisted positioning=2. In some implementations, the WTRU receives coordinates for corners of the deployment area and a threshold distance from the corners for corner detection. In some implementations, the WTRU is configured with a RAT-dependent non-ML positioning method (e.g., DL-TDOA). In some implementations, the WTRU takes measurements on PRS. In some implementations, the WTRU provides one or more measurements (e.g., RSRP) to the RAT dependent non-ML positioning (e.g., DL-AoD) and obtains its position and uses this position as a location estimation.

In some implementations, the WTRU makes the following determination related to positioning: If the WTRU determines that it is in a corner based on the difference between WTRU location estimate and one of the corner coordinates being below the threshold corner detection distance, the WTRU determines to use a ML assisted positioning method. If the WTRU determines that it is in a corner and that the number of TRPs with a LOS indicator is equal to or above the threshold, the WTRU determines to use multi-TRP fingerprinting and returns an estimated location. If the WTRU determines that it is in a corner and that a number of TRPs with a LOS indicator is below the threshold, the WTRU determines to use single-TRP fingerprinting and returns an estimated location. If the WTRU determines that it is not located in a corner based on the minimum value of differences between the WTRU location estimate and all the corner coordinates being above the threshold distance, the WTRU returns the position previously obtained.

In some implementations, the WTRU returns its estimated position to the LMF. In another example, the WTRU returns its estimated position and reports the positioning method used to determine the estimated position to the LMF.

Some implementations include WTRU-based adaptive hybrid positioning. In some implementations, the WTRU receives TRP locations and associated LOS/NLOS indicators from the network. The WTRU receives a LOS threshold and a LOS TRP threshold. In some implementations, the WTRU is configured with a RAT-dependent positioning method (e.g., DL-TDOA). The WTRU receives configurations for a multi-RTT positioning method. In some implementations, the WTRU takes measurements on PRS. In some implementations, the WTRU obtains a position estimate from the ML model based positioning (e.g., multi-TRP fingerprinting based measurements) based on the measurements.

In some implementations, the WTRU makes the following determination related to the follow-up positioning: If the WTRU determines that it is located in a corner (e.g., based on a difference between the WTRU location and a corner coordinate being below the threshold) and that the number of TRPs with a LOS indicator is above the LOS threshold is greater than or equal to the LOS TRP threshold, the WTRU determines to use multi-RTT. If the WTRU determines that it is located in a corner but that the number of TRPs with a LOS indicator above the LOS threshold is less than the LOS TRP threshold, the WTRU returns the location estimate from the ML. If the WTRU is not located in a corner, the WTRU determines to use the configured RAT-dependent positioning method. In some implementations, the WTRU returns its estimated position to the LMF.

Some implementations relate to positioning method selection. For example, in some cases a WTRU may be located in a corner of a deployment area. In some cases, if a WTRU located in the corner of the deployment area were to apply a conventional positioning method (e.g., DL-TDOA), positioning accuracy may degrade (e.g., severely) e.g., since all the TRPs are located in the same direction with respect to target WTRU. In some implementations, if a WTRU identifies that it is located in a corner of a deployment area, the WTRU may use single TRP AIML positioning method to obtain a more accurate position (e.g., as compared with conventional positioning). In some implementations, using a single TRP AIML positioning method, the WTRU may determine its location by providing one or multiple measurements from the same TRP to an AIML model (e.g., a RSRP fingerprint created by RSRP measurements of multiple beams from the same TRP).

In some implementations, the WTRU may receive one or more TRP ID(s) associated with a corner and a condition for corner association (e.g., the WTRU is within a preconfigured distance threshold from the TRP associated the corner, or the WTRU is located within a preconfigured distance threshold from one of the corners, etc.), e.g., from the network. For example, in some implementations, the WTRU may determine coordinates of corners of a room based on assistance data sent from the network. In some implementations, the WTRU may be configured with TRP ID(s) associated with each corner (e.g., configured coordinates). In some implementations, the WTRU may determine that a TRP is associated with a corner if the TRP is located within a preconfigured threshold distance from the coordinates of the corner. In some implementations, after fulfillment (e.g., if the WTRU is within the preconfigured threshold from the TRP associated with the corner, the WTRU is located within the preconfigured threshold from one of the corners) of the condition for corner association, the WTRU may determine that it is located in the corner and may use single TRP AIML positioning to obtain its position.

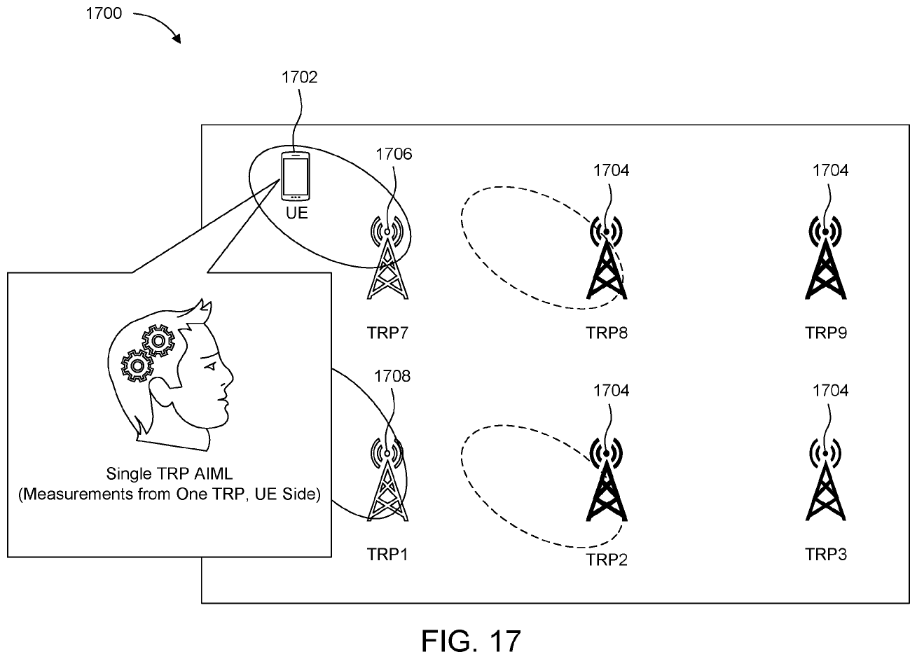

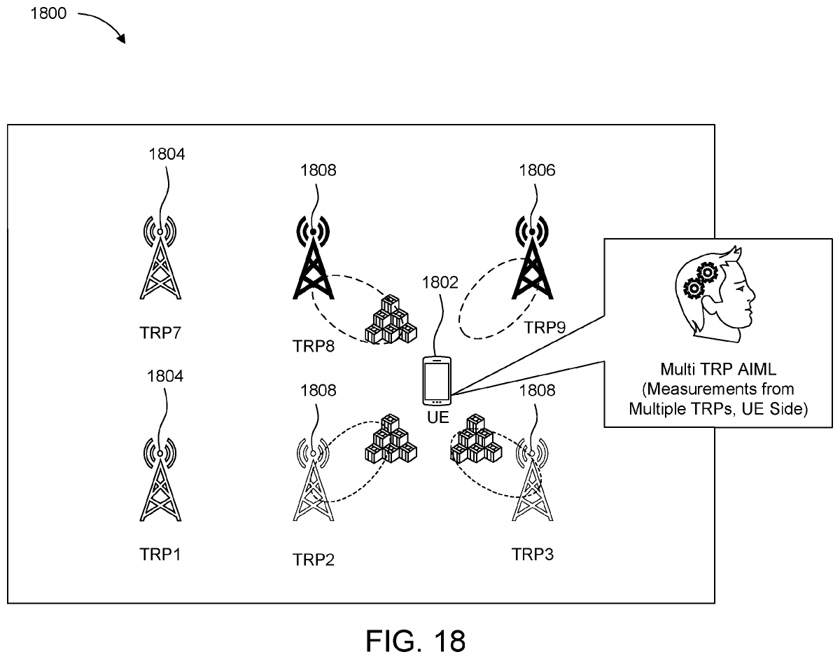

FIG. 17 is a system diagram 1700 illustrating an example WTRU 1702 in an example scenario where the WTRU 1702 is located in a corner of the environment (e.g. bounded by walls, buildings, or other structures or signal-blocking elements, or otherwise separated from other transmitters or other devices on two or more sides). The WTRU 1702 is labeled “UE” in the figure, however any suitable WTRU may be used. In this example, the network indicates to the WTRU 1702 that TRP7 1706 and TRP1 1708 are associated with the upper left corner (with TRPs 1704 not associated with the corner). The network (e.g., LMF, gNB) also indicates to the WTRU 1702 a condition for corner association. It is noted that in some implementations, the condition may be received by the WTRU 1702 from another device (e.g., a sensor) and/or in any other suitable manner, and/or may be pre-configured. In this example, the condition for corner association indicates that the WTRU should be associated with the corner if the RSRP from any of the TRPs associated with the corner (1706, 1708) is above the threshold. In another example, the condition for corner association may indicate that the WTRU should be associated with corner if the RSRP from any of the beam ID associated with the corner from any of the TRPs associated with the corner is above the threshold. If the WTRU 1702 meets the condition (e.g. if an RSRP from either or both of TRP 7 and TRP1 is above the threshold), it associates itself with that corner (e.g., the WTRU determines that it is in the corner). If the WTRU 1702 associates itself with a corner, in some embodiments, the WTRU may determine the positioning method that is configured to locate the WTRU in the corner (e.g., single TRP based AIML positioning). In this example, the WTRU 1702 receives a RSRP threshold for corner association from the network. In this example, the WTRU receives a PRS from TRP1, TRP2, TRP7 and TRP8, and determines that the measured RSRP of TRP7 is above the RSRP threshold for corner association (in this example, the measured RSRP of TRP1, TRP2, and TRP 8 may or may not be above the threshold). Since TRP7 is associated with the upper left corner, the WTRU 1702 determines that it is located in the upper left corner. Based on the association with a corner, the WTRU 1702 uses single TRP AIML positioning method to obtain its position. In one example, based on configuration, the WTRU 1702 may determine to use the single TRP AIML positioning method that is applicable to any corners of the room. In another example, the WTRU 1702 may be configured with a single TRP AIML positioning method associated with each corner of the room. In this case, the WTRU 1702 may determine which corner the WTRU is associated with, and determine which single TRP AIML positioning method the WTRU shall use.

In some cases a WTRU may be located in an NLOS heavy environment; e.g., where the WTRU is in NLOS condition with majority of the TRPs it received PRS from. In such cases, if the WTRU were to apply conventional positioning method, the WTRU may observe degradation in accuracy, e.g., due to inaccurate positioning measurements from NLOS TRPs. In some implementations, if the WTRU detects an NLOS heavy environment, the WTRU may apply a multi TRP AIML positioning method and obtain its location, e.g., to determine its position with higher positioning accuracy as compared with conventional positioning. In some implementations, the network provides a LOS indicator (e.g., LOS indicator value=0 for NLOS TRP and LOS indicator value=1 for LOS TRP) associated with each TRP such that the WTRU may determine whether it is in an NLOS heavy environment. The WTRU receives a LOS TRP threshold value for NLOS environment detection from the network. If the WTRU determines that the number of observed LOS TRPs is less than the LOS TRP threshold, the WTRU may determine that it is in an NLOS heavy environment, and may determine to use a multi TRP positioning method to obtain its location.

FIG. 18 is a system diagram 1800 illustrating an example WTRU 1802 in an example scenario where the WTRU 1802 is located in an example NLOS environment. The WTRU 1802 is labeled “UE” in the figure, however any suitable WTRU may be used. In this example, the WTRU 1802 receives an LOS TRP threshold value for NLOS environment detection, where the threshold value=3 (e.g., 3 TRPs in LOS) (other thresholds may be used in other embodiments, such as 2, 4, 5, 10, or any other such value). The WTRU also receives PRS and LOS indicators from TRP2, TRP3, TRP9 and TRP8. Since this WTRU 1802 is in an LOS condition with only 1 TRP (TRP9 1806) which is below the threshold for NLOS environment detection in this example scenario (with NLOS TRPs 1808 obscured or blocked from LOS), the WTRU 1802 determines that it is in an NLOS heavy environment and applies a multi TRP AIML positioning method to estimate its location. In some embodiments, the comparison of LOS indicators (or NLOS indicators) to the LOS TRP threshold may be referred to as a required rate of NLOS predictions, such that if the required rate of NLOS predictions is exceeded, then a multi-TRP AI/ML positioning method may be utilized.

In some cases a WTRU may be located in a part of a deployment area where it is neither in a corner nor in an NLOS environment. In some such conditions the WTRU may use (or continue using) a conventional positioning method (e.g., DL-TDOA).

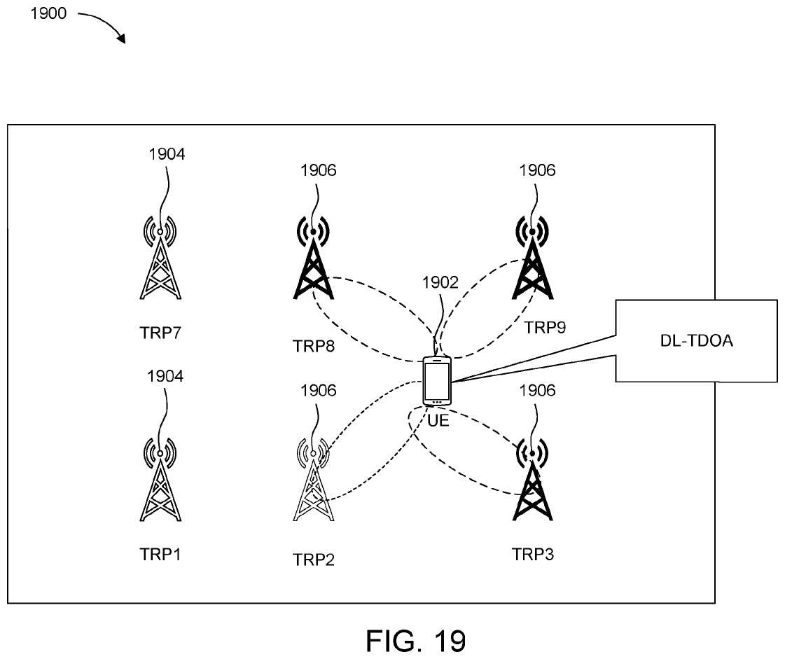

FIG. 19 is a system diagram 1900 illustrating an example WTRU 1902 in an example scenario where the WTRU 1902 is in an LOS environment (e.g., where the WTRU located in a part of a deployment area where it is neither in a corner nor in an NLOS environment, as it has LOS connections to TRPs 2, 3, 8, and 9 (identified as LOS TRPs 1906), with TRPs 1904 being out of range in the example). The WTRU 1902 is labeled “UE” in the figure, however any suitable WTRU may be used. In this scenario, the WTRU 1902 may use (or continue using) a conventional positioning method, e.g., since AIML positioning methods (e.g., single TRP positioning or multi TRP positioning) in general require more overhead for training and transferring of models and may not provide any additional accuracy gain compared to the conventional methods in an LOS environment.

In some embodiments such as the examples of FIGS. 17-19, the physical environment or positioning of the WTRU may be referred to as a spatial configuration relative to the TRPs. For example, in FIG. 17, the spatial configuration of the WTRU may be defined as in or associated with a corner (or proximate to or associated with a TRP that is itself associated with a corner). In FIG. 18, the spatial configuration of the WTRU may be defined as in an NLOS environment. In FIG. 19, the spatial configuration of the WTRU may be defined as in an LOS environment. Accordingly, a spatial configuration of the WTRU or other device may refer broadly to the relative positioning of the WTRU or other device to one or more TRPs, corners, and/or other objects that block LOS transmissions.

Similarly, in some embodiments, the various positioning models or algorithms may be referred to as a position determination algorithm. For example, a position determination algorithm may include a single-TRP AI/ML position prediction model, a multi-TRP AI/ML position prediction model, or a non-AI/ML positioning method.

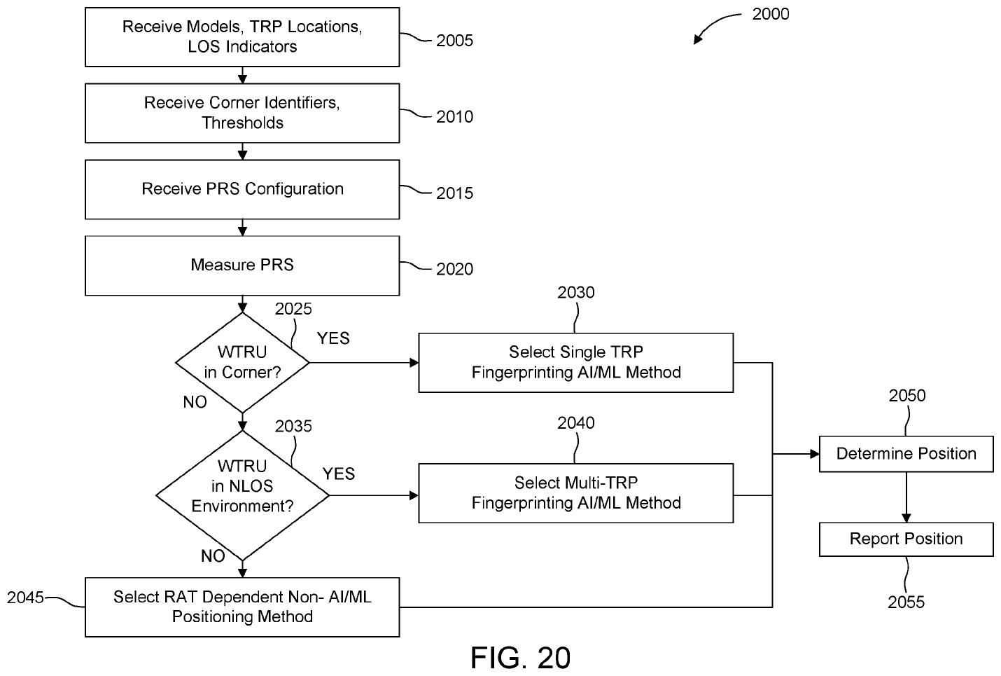

FIG. 20 is a flow chart illustrating an embodiment of a method 2000 for ML-assisted position estimation. In brief overview, in some embodiments, at 2005, a device may receive models, TRP locations, and/or LOS indicators. At 2010, the device may receive corner identifiers and/or thresholds. At 2015, the device may receive one or more PRS configuration identifiers. At 2020, the device may measure PRS signals. At 2025, the device may determine whether it is in a corner. If so, at 2030, the device may select a single TRP fingerprinting model. If not, at 2035, the device may determine if it is in an NLOS environment. If so, at 2040, the device may select a multi-TRP fingerprinting model. If not, at 2045, the device may select a RAT-dependent positioning algorithm. At 2050, the device may use the selected model or algorithm to determine its position. At 2055, the device may report its position to the network. It is noted that in some implementations, some or all of the actions and/or conditions may be omitted or rearranged. For example, in some implementations, condition 2035 and action 2040 are omitted, or condition 2025 and action 2030 are omitted.

Still referring to FIG. 20 and in more detail, at 2005, a device may receive models, TRP locations, and/or LOS indicators. The device may be or include a WTRU, UE, or other wireless device. In some embodiments, the device may receive one or more models for AI/ML assisted positioning, such as a single TRP fingerprinting model or a multi TRP fingerprinting model, as discussed above. In some embodiments, the models may include a single unified model. In some embodiments, the models may be separate. Where there are multiple models, the models may be homogenous (e.g. similar neural networks with different weights or biases) or heterogeneous (e.g. a DNN and a Bayesian classifier, or any other combination of different AI models or algorithms). For example, in some implementations, the device may include hardware for executing a neural network, such as a TPU co-processor, ASIC, or other circuitry. Weights of a selected model maybe loaded as firmware into the circuitry, allowing execution of the model on the hardware.

In some embodiments, the device may receive TRP location information. The TRP location information may be in any suitable format, such as rectangular or polar coordinates from a given origin; in relative or absolute positions; or any other type and form of location information. In many embodiments, the TRP location information may be associated with each TRP according to a TRP identifier.

In some embodiments, the device may receive LOS indicators associated with each TRP identifier. As discussed above, LOS indicators may be binary flags (e.g. 1 or 0), data strings, or other predetermined signals. In some embodiments, 2005 may include one or more additional sub-procedures; for example, in some embodiments, the device or WTRU may transmit a request for TRP location information and/or LOS indicators, and the TRP(s) or another network device (e.g. LMF, gNB, etc.) may respond with the requested information. In some embodiments, models may be pre-loaded into memory of the device. Accordingly, in some such embodiments, 2005 may be considered to cover a substantial period of time (e.g. loading models during an overnight system update, and transmitting a request for TRP locations and/or LOS indicators when accessing the network some time later). Pre-loading of models may also be considered to be a separate precursor procedure (not illustrated) in some embodiments.

In some embodiments, at 2010, the device may receive corner identifiers and/or thresholds. In some embodiments, the corner identifiers may include a list of TRPs whose coverage includes corners (e.g. corners of the wireless environment or boundaries beyond which other TRPs are not available; corners in which a device may be blocked from receiving signals on two or more sides by walls or environmental objects; etc.). Identification of a TRP as being associated with a corner may be determined by a system administrator, installer, engineer, or other entity, or may be dynamically determined (e.g. by the TRP performing discovery protocols to identify other accessible TRPs, by measuring broadcast signals at various directions to detect walls based on reflections or returns, or in any other such method). In some instances, no TRPs may be associated with a corner—accordingly, in some such embodiments, no corner identifiers may be provided to the device (e.g., no response to a query for corner identifiers, or a blank response, etc.); in other embodiments, an explicit negative response may be provided to the device (identifying that no TRPs are associated with corners). In some embodiments, each TRP identifier may be associated with a flag or string or predetermined bit to indicate whether it associated with a corner; accordingly, in some such embodiments, the TRP identifiers and corner identifiers may be provided together (e.g. at 2005).

In some embodiments, the device may receive one or more thresholds. For example, in some embodiments, the device may receive an RSRP threshold for measuring whether the device is proximate to or within coverage of a corner TRP. In some embodiments, the device may receive a threshold number of TRPs for indicating a LOS or NLOS environment. The thresholds may be provided together or via separate messages. In some embodiments, 2010 may include one or more additional sub-procedures. For example, in some embodiments, the device may transmit one or more requests for thresholds and/or corner identifiers, and may receive one or more corresponding responses. Although shown separate from 2005, in some embodiments, 2005 and 2010 may be combined (e.g. the device may transmit a request for TRP location information, LOS indicators, and corner identifiers; and may receive corresponding information). Similarly, as discussed above, in some embodiments, thresholds may be loaded into memory of the device at an earlier time (e.g. during a periodic system update). Accordingly, parts of 2010 may occur simultaneously with, before, or after 2010.

At 2015, the device may receive a PRS configuration. As discussed above, the PRS configuration may identify one or more TRPs that the device may receive a PRS from. The PRS configuration may be transmitted by a TRP or any suitable network device (e.g. LMF, gNB, etc.), and may, in some embodiments, be provided to the device as a response to a transmitted request for a PRS configuration.

Although shown separate, in some embodiments, 2015 may occur as part of 2005 or 2010. For example, in one such embodiment, the device may transmit a request for TRP locations, LOS indicators, corner identifiers, and a PRS configuration, and may receive one or more corresponding responses including the requested information.

At 2020, the device may measure PRS signals. The device may measure received signal strength, signal loss relative to an indicated transmission strength, time of flight based on a synchronized clock and transmission timestamp, and/or any other such measurements. Although shown as a single procedure, in many embodiments, the device may measure PRS signals from a plurality of TRPs, and accordingly, 2020 may be performed for each TRP serially or in parallel in various embodiments.

At 2025, the device may determine whether it is in a corner or associated with a corner. In some embodiments, the device may determine whether an RSRP from a TRP identified as being associated with a corner is above a threshold. This may indicate that the device is proximate to the TRP associated with the corner and, therefore, is similarly associated with a corner. Accordingly, in many embodiments, the device may not directly determine whether it is in a corner, but may determine that it is nearby a TRP associated with a corner and is therefore also associated with the corner. In some embodiments, rather than or in addition to RSRP, other measurements may be utilized, such as time of flight of signals from the TRP(s). In some instances, as discussed above, measurements from multiple TRPs associated with corners may exceed the threshold; such measurements may indicate that multiple corners are near each other in the environment, or that multiple TRPs are associated with the same corner (which may be advantageous in instances in which other obstacles exist in the environment near the corner that may affect RSRP or other measurements).

If the device determines that it is associated with a corner based on the measurements of the TRP or TRPs associated with the corner, at 2030 in some embodiments, the device may select a single TRP fingerprinting model. As discussed above, the single-TRP fingerprinting model may include any type and form of AI/ML model, such as weights and biases for a neural network or other classifier, that is trained to determine a location within a corner-associated environment from measurements associated with a single TRP.

If the device determines that it is not associated with a corner based on the measurements of the TRP or TRPs associated with the corner, in some embodiments at 2035, the device may determine if it is in an NLOS environment. As discussed above, in some embodiments, the device may determine whether the number of LOS indicators received from the network and/or TRPs is below the LOS TRP threshold. If so, the device may determine that it is in an NLOS environment. In some other embodiments, the device may determine whether the number of NLOS indicators received from the network and/or TRPs is above an NLOS TRP threshold. If so, the device may determine that it is in an NLOS environment.

If the device determines that it is in an NLOS environment, in some embodiments at 2040, the device may select a multi-TRP fingerprinting model. As discussed above, the multi-TRP fingerprinting model may include any type and form of AI/ML model, such as weights and biases for a neural network or other classifier, that is trained to determine a location within an environment from measurements associated with TRPs having LOS to the device.

If the device determines that it is not in an NLOS environment, in some embodiments at 2045, the device may select a RAT-dependent positioning algorithm or other positioning method, such as DL-TDOA, DL-AoD, Multi-RTT, UL-TDOA, UL-AoA, or any other suitable method. As discussed above, because the device may have LOS to a sufficient number of TRPs, the RAT-dependent positioning algorithms may have higher accuracy than fingerprinting models, may be faster, may require less power or computational resources, or be otherwise desirable in such instances, in many embodiments.

At 2050, in some embodiments, the device may use the selected model or algorithm to determine its position (e.g. single-TRP fingerprinting ML model, multi-TRP fingerprinting ML model, other positioning algorithm, etc.). As discussed above, using the model may include loading the model as firmware into a TPU or other co-processor or hardware accelerator, loading the model into RAM or other memory, applying weights and biases to the nodes and edges of the model, and providing input data to the model and reading output data. In some embodiments, providing input data to the model may include normalizing input data such as RSRP measurements or other input data, transcoding the data into a vector or array, or otherwise pre-processing the data. In some embodiments, input data may be filtered, truncated, scaled, or otherwise pre-processed. Similarly, output data may be processed, transcoded, filtered, truncated, or otherwise configured into position data for transmission to the network.

At 2055, in some embodiments, the device may report its position to the network based on the output of the model or algorithm. The position report may be via any suitable type and form of transmission and may be transmitted independently, as part of another transmission such as a data uplink, and/or in response to request from another device (e.g. LMF, gNB, TRP, etc.).

Accordingly, the present disclosure is directed to methods, devices, and systems for machine learning (ML)-assisted positioning. An ML assisted non-line-of-sight (NLOS) identification request and capability information are sent to a network device. A first list of trained ML models and input features are received, responsive to the identification request and capability information. A model for NLOS identification is selected, based on a required rate of NLOS predictions. NLOS transmission-reception points (TRPs) are predicted based on the selected model. A position is determined based on the predicted NLOS TRPs

In some implementations, a WTRU may enhance its positioning accuracy and select the most efficient positioning technique using a method including some or all of the following procedures, in the following or in a different order:

In some implementations, the WTRU may receive AI/ML models for AI/ML assisted positioning, TRP locations and associated LOS indicators (e.g., 1 or 0) from the from the network (e.g., from an LMF or gNB). In some implementations the WTRU may receive, e.g., from the network, a list of TRP IDs associated with corners (e.g., TRPs whose coverage includes corners), a first threshold (e.g., RSRP) and a second threshold (e.g., number of LOS TRP). In some implementations the WTRU may receive a PRS configuration from the network (e.g., LMF, gNB). In some implementations the WTRU may take PRS measurements. In some implementations the WTRU may determine that it is located in a corner associated to a corner TRP if the RSRP measured from at least one of the corner TRPs is above the first threshold. In some implementations the WTRU may determine that it is in a NLOS environment if the number of LOS TRPs is less than the second threshold.

In some implementations the WTRU may select a positioning method, where if the WTRU is located in a corner, the WTRU selects single TRP fingerprinting AI/ML positioning method. If the WTRU is not located in a corner but is in a NLOS environment, the WTRU selects a multi-TRP fingerprinting AI/ML positioning method; or otherwise, if the WTRU is not located in a corner and is not in a NLOS environment, the WTRU selects a configured RAT dependent non-AI/ML positioning method (e.g., DL-TDOA). It is noted that in some implementations the WTRU determines the single TRP fingerprinting AI/ML positioning method as the positioning method when the WTRU determines that it is located in the corner. Since fingerprints of measurements can capture both LOS and/or NLOS characteristics in measurements, single TRP fingerprinting AI/ML positioning method is able to adapt to diverse scenarios (e.g., corner with LOS only, corner with LOS and NLOS, corner with NLOS only).

In some implementations the WTRU may obtain its position using the selected positioning method. In some implementations the WTRU may report its position to the network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-40. (canceled)

41. A method for use in a wireless transmit/receive unit (WTRU), the method comprising:
receiving information indicating transmission reference points (TRPs) associated with corners, and information indicating a reference signal received power (RSRP) threshold, the TRPs associated with corners including a first TRP;
determining that the WTRU is located in a corner based on an RSRP of a positioning reference signal (PRS) received from the first TRP being above the RSRP threshold;
determining, by the WTRU, position information based on an artificial intelligence/machine learning (AI/ML) position model and the determination that the WTRU is located in the corner; and
transmitting information indicating the position of the WTRU.

42. The method of claim 41, wherein the AI/ML position model comprises a single-TRP fingerprinting AI/ML position model.

43. The method of claim 42, wherein the single-TRP fingerprinting AI/ML position model comprises weights for a neural network.

44. The method of claim 41, wherein the AI/ML position model comprises a support vector machine (SVM) or k-nearest neighbor (KNN) model.

45. The method of claim 41, wherein a TRP is associated with a corner based on its proximity to a corner of a deployment environment.

46. The method of claim 41, wherein the WTRU has a line-of-sight (LOS) path to the first TRP.

47. The method of claim 41, wherein inputs to the AI/ML position model include peak power or average power measurements of one or more transmissions from the first TRP.

48. A wireless transmit/receive unit (WTRU) comprising:
receiver circuitry configured to receive information indicating transmission reference points (TRPs) associated with corners, and information indicating a reference signal received power (RSRP) threshold, the TRPs associated with corners including a first TRP;
processing circuitry configured to determine that the WTRU is located in a corner based on an RSRP of a positioning reference signal (PRS) received from the first TRP being above the RSRP threshold;
the processing circuitry further configured to determine position information based on an artificial intelligence/machine learning (AI/ML) position model and the determination that the WTRU is located in the corner; and
transmitter circuitry configured to transmit information indicating the position of the WTRU.

49. The WTRU of claim 48, wherein the AI/ML position model comprises a single-TRP fingerprinting AI/ML position model.

50. The WTRU of claim 49, wherein the single-TRP fingerprinting AI/ML position model comprises weights for a neural network.

51. The WTRU of claim 48, wherein the AI/ML position model comprises a support vector machine (SVM) or k-nearest neighbor (KNN) model.

52. The WTRU of claim 48, wherein a TRP is associated with a corner based on its proximity to a corner of a deployment environment.

53. The WTRU of claim 48, wherein the WTRU has a line-of-sight (LOS) path to the first TRP.

54. The WTRU of claim 48, wherein inputs to the AI/ML position model include peak power or average power measurements of one or more transmissions from the first TRP.

55. A method implemented in a wireless transmit/receive unit (WTRU), the method comprising:
receiving information indicating a reference signal received power (RSRP) threshold for transmission reference points (TRPs) associated with line-of-sight (LOS) communications, and receiving information indicating a threshold number of TRPs associated with LOS communications;
determining a total number of TRPs associated with LOS communications for which RSRP measured on a received position reference signal (PRS) is below the RSRP threshold;
determining that the WTRU is located in a non-line-of-sight (NLOS) environment based on the determined total number of TRPs being greater than the threshold number of TRPs;
determining, by the WTRU, position information based on an artificial intelligence/machine learning (AI/ML) position model and the determination that the WTRU is located in the NLOS environment; and
transmitting information indicating the position of the WTRU.

56. The method of claim 55, wherein the AI/ML position model comprises a multi-TRP fingerprinting AI/ML position model.

57. The method of claim 56, wherein the multi-TRP fingerprinting AI/ML position model comprises weights for a neural network.

58. The method of claim 55, wherein the AI/ML position model comprises a support vector machine (SVM) or a k-nearest neighbor (KNN) model.

59. The method of claim 55, wherein the indication of TRPs associated with LOS communications comprises a list of TRP identifiers and an associated predetermined bit indicating either LOS or non-line-of-sight (NLOS).

60. The method of claim 55, wherein inputs to the AI/ML position model include peak power or average power measurements of one or more transmissions from each of a plurality of TRPs associated with LOS communications.
